(19) United States
(12) Patent Application Publication
(10) Pub. No.: US 2017/0247133 A1
(43) Pub. Date: Aug. 31, 2017

(54) DISTRIBUTION OF COINS IN BAGS

(71) Applicant: SCAN COIN AB, Malmo (SE)

(72) Inventor: Anders Sjostrom, Lund (SE)

(73) Assignee: SCAN COIN AB, Malmo (SE)

(21) Appl. No.: 15/508,495

(22) PCT Filed: Sep. 14, 2015
(86) PCT No.: PCT/SE2015/050962

§ 371 Date: Mar. 3, 2017

(30) Foreign Application Priority Data
Sep. 15, 2014 (SE) 1451064-8

(51) Int. Cl. B65B 57/00; B65B 61/06; G07D 1/00

(52) U.S. Cl. CPC B65B 57/00; G07D 1/00; B65B 61/06

(57) ABSTRACT

The present inventionrelates to the field of cash handling, and in particularly handling of coins. More specifically, the present invention relates to a dispensing apparatus for dispensing coin bags.

The present invention relates to the field of cash handling, and in particularly handling of coins. More specifically, the present invention relates to a dispensing apparatus for dispensing coin bags.

### TECHNICAL BACKGROUND

Today, coins may be distributed from institutions such as banks to end users such as stores, shops, markets, companies and private persons, in units such as coin rolls or coin bags. The dispensing of such coin units is typically carried out by dispensing machines or in bank offices where users buy rolls or bags and pays with cash or cards. There is a general trend towards using automatic dispensing machines rather than expensive manual cash handling. Cash-in-transit companies are also often interested in providing automatic dispensing machines in cash-handling offices of stores, shops etc.

As already mentioned, it is quite common in some countries to distribute coins in rolls wrapped in paper. Coin rolls are compact, stable and easy to mark with information. However, it may be difficult to open a densely wrapped coin roll.

Coin bags constitute an alternative to coin rolls. A coin bag is normally a heat-sealed plastic bag containing a specific amount, typically 20-100 coins. The advantages of using coin bags are primarily associated with production as it is much easier and up to 50% cheaper to fill up a coin bag than producing a coin roll. Other advantages with coin bags are that they are easy to open and that it is possible to remove some but not all of the coins therein.

Coin bags are, however, also associated with some drawbacks. A bag filled with coins does not have any specific three-dimensional shape. Accordingly, it is difficult to pile up and store a multitude of such bags. It is also very difficult to estimate the amount of bags in a pile without counting the bags. Moreover, compared with the coin rolls solution, it is much more complex to manufacture a cash dispenser for bags of coins since each bag may have a different shape. Indeed, there is no efficient available automatic dispensing solution which could facilitate dispensing of the bags and cut the costs thereof.

Accordingly, there is a need for an improved system for distributing coin bags to end users.

### SUMMARY OF THE INVENTION

The present invention aims at solving the above mentioned problems by providing, in a first aspect a dispensing apparatus for dispensing coin bags, the dispensing apparatus comprising: a dispense aperture through which coin bags are dispensed; a cutting device for cutting of a coin bag from a chain of a plurality of interconnected coin bags, a bag storage compartment adapted for receiving a first and a second container, each containing a chain of a plurality of interconnected coin bags, the bag storage compartment having a first storage position and a second storage position, the bag storage compartment further comprising a first conveyor belt for transporting a container in the second storage position to the first storage position, a bag transporting device adapted for guiding the chain of a plurality of interconnected coin bags to said cutting device followed by said dispense aperture, a transition area located at the interface between the bag storage compartment and the bag transporting device, an output compartment for receiving and putting out empty containers, wherein the dispensing apparatus further comprises a container removing device adapted for transferring the first container at the first storage position to the output department when all interconnected bags of the chain originally enclosed therein have been transported out therefrom, and wherein the first conveyor belt is adapted for transporting the second container from the second storage position to the first storage position subsequent to the removal of the first container by the container removing device.

As disclosed herein, the term “container” relates to a structure suitable for enclosing a plurality of coin bags. It must have an upper opening enabling coin bags to enter and exit. It must be broader than the coin bags that are to be stored therein. The container may have many different shapes. A circular or hexagonal vertical cross-section is possible. However, the container shape is typically an essentially rectangular block having a bottom side, two short sides, two long sides and an upper side comprising an opening. For practical reasons, the weight of a container filled with coin bags should not exceed 20 kg, preferably not exceed 15 kg, and most preferably not 10 kg.

As disclosed herein, the terms “chain of a plurality interconnected coin bags” or “chain of interconnected coin bags” relates to a chain of plastic bags containing coins. Typically, such a chain has been obtained by filling coins into a plastic tube and closing the space occupied by the coins by heat-sealing. Suitable plastic materials are heat-sealable and sufficiently strong to be able to enclose heavy metal coins. Polypropylene is an example of a suitable plastic material. It is easy for a skilled person to find more suitable such materials. The chain furthermore has a first end and a second end. These ends preferably consist of heat-sealed portions. The ends of the chain are adapted for being releasably attached to the clamping devices of the container.

As disclosed herein, the term “seal” relates to an elongated sheet, or otherwise shaped sheet depending on the shape of a container to be sealed, adapted for being attached to the container in order to indicate that the container contains a chain of interconnected coin bags and to provide further information, such as the specific amount of coin bags in the container and the amount and type of coins in the bags. The seal comprises an information part and two end parts at the short sides of the elongated sheet. There are anti-tamper seals at both end parts. Furthermore, there is a double-adhesive part releasably attached to the lower side of the main part in vicinity of one or both the end parts.

As disclosed herein, the term “anti-tamper seal” relates to a part that adheres to a surface. When the part is removed from the surface, there is a display on the part itself and/or the surface to which it has adhered indicating that the seal has been manipulated and/or opened. Such anti-tamper seals are commercially available. The anti-tamper seal is firmly attached to the main part of the seal, typically by a glue.

As disclosed herein, the term “double-adhesive part” relates to a sheet structure having an adhesive on both sides. Typically, the double-adhesive part is arranged on the lower side of the main part of the seal in vicinity of an end part. Both sides of the double-adhesive part are intended to adhere to ends of chains of interconnected coin bags. The side of a double-adhesive part on a seal facing away from the main part is intended to adhere to an end part of a chain of interconnected coin bags that has been arranged inside a container to be sealed. When a seal of a container is removed, the other side of the double-adhesive part is exposed and may be used for adhering to an end part of another chain of interconnected coin bags. It is important to note that the double-adhesive part also may be fastened on the chain of interconnected coin bags without using the above described seal. For example, the double-adhesive part may comprise a protective film which can manually be peeled off to expose the other side of the double-adhesive part and then used for adhering to an end part of another chain of interconnected coin bags.

As disclosed herein, the term “press area” relates to an area on the upper short side of a container adapted for receiving an end part of a chain of interconnected coin bags. The press area may either protrude out from said upper short side or be at the same level as the rest of the short side. The function of the press area is to provide support to the double-adhesive parts when two chains of interconnected coin bags are joined.

As disclosed herein, the term “clamping device” relates to a device adapted for sticking or attaching one of the ends of a chain of interconnected coin bags, typically a clamp or a clip. In some embodiments, the end of said chain is only loosely attached to the clamping device and may be pulled out from it.

As disclosed herein, the term “actuation means” relates to a means located on a short side of the container for releasing the clamping device when short sides of two different containers are pressed against each other. Accordingly, a suitable actuation means may be a push button on the surface, in a cavity or on a protruding part. In one embodiment one surface of a short side may comprise a protruding part whereas the other short side surface may comprise a cavity receiving the protruding part. The actuation means may also comprise a proximity sensor sensing if an object, for example a second container, is in the vicinity. According to some embodiments, the actuation means may comprise a sensor which only actuates if it senses a certain object, typically an object on the second container.

In some embodiments, the output compartment includes a declining surface and container removing device is adapted for transferring the first container to the declining surface.

In some embodiments, the bag storage compartment also comprises a third storage position for receiving a third container, and a second conveyor belt adapted for transporting the third container from the third storage position to the second storage position subsequent to the removal of the second container from the second storage position by the first conveyor belt.

In some embodiments, the first storage position and the second storage position are immediately adjacent to each other in such a way that the second short side of a container in the first storage position is in contact with the first short side of a container in the second storage position.

In some embodiments, the second storage position and the third storage position are immediately adjacent to each other in such a way that the second short side of a container in the second storage position is in contact with the first short side of a container in the third storage position.

In some embodiments, the apparatus further comprising a means for counting the amount of coin bags that has been transferred from the storage compartment.

In some embodiments, the apparatus further comprising a means for obtaining amount information about the coins and/or coin bags to be dispensed, selected from the group of

a) a QR code reader adapted for reading information on a container, or a coin bag or on the information part of a seal;

b) a RFID reader adapted for reading information on a container, or a coin bag or on the information part of a seal; and

c) a means for manually entering information such as a key pad.

In some embodiments, the apparatus further comprising a sensor for detecting the position of the chain of a plurality of interconnected coin bags in the transition area.

In some embodiments, the apparatus further comprises a means for receiving a sensor signal from a container in said first storage position, said signal indicating presence of a chain of interconnected coin bags in said container.

In some embodiments, the apparatus further comprises a control system for controlling at least the cutting device, first conveyor belt, bag transporting device, and the container removing device.

In some embodiments, said control system is adapted for receiving information about the amount of interconnected coin bags of a chain in a container in the first storage position, said control system being adapted to determining in real time whether there are any interconnected coin bags left in the container, and if the control system has determined that there are no remaining interconnected coin bags in the container, the control system is adapted to instruct the container removing device to transfer the container to the output compartment.

In some embodiments, the control system determines whether there are any interconnected coin bags left in the container based one or more of the following input data:

i) information from a means for obtaining amount information about the coins and/or coin bags to be dispensed in accordance with above;

ii) information from a sensor for detecting the position of the chain of a plurality of interconnected coin bags in the transition area in accordance with above;

iii) information from a means for receiving a sensor signal from a container in said first storage position, said signal indicating presence of a chain of interconnected coin bags in said container; and

iv) information from the cutting device and/or the bag transporting device about the amount of bags that have been transported away from the bag storage compartment.

In some embodiments, said control system is adapted for instructing the first conveyor belt to forward a container in the bag storage compartment to the first storage position in case there is no container in the first storage position.

### DESCRIPTION OF THE ENCLOSED FIGURES

The above, as well as additional objects, features and advantages of the present invention, will be better understood through the following illustrative and non-limiting detailed description of embodiments of the present invention, with reference to the appended drawings, where the same reference numerals will be used for similar elements, wherein:

FIG. 1 shows a dispensing apparatus according to embodiments of the invention,

FIG. 2 shows a container comprising a plurality of interconnected bags for coins,

FIG. 3 shows a close up of a clamp of FIG. 2,

FIG. 4 describes a fastening procedure for an end of the plurality of interconnected bags for coins using the clamp of FIG. 3,

FIG. 5a shows an upper side of a sealing suitable for sealing an opening of a container of claim 1,

FIG. 5b shows a side view of the sealing of FIG. 5a,

FIG. 5c shows a cut out of an end portion of the sealing of FIG. 5b,

FIG. 6a shows the sealing of FIGS. 5a-c when covering an opening of the container of FIG. 2,

FIG. 6b describes an opening procedure of the container of FIG. 6a,

FIGS. 7a-b describe a method for forming an uninterrupted chain of coin bags according to embodiments of the invention,

FIG. 8 shows the dispensing apparatus of FIG. 1 when receiving the container of FIG. 2,

FIGS. 9a-d describe the process of dispensing bags for coins according to embodiments of the invention,

FIG. 10 schematically shows the dispensing concept of bags for coins,

FIG. 11a shows by way of example a structure of a lifting device for lifting the interconnected bags from a bag storage compartment of the dispenser,

FIGS. 11b-c show how the chain of interconnected bags are lifted with the lifting device of FIG. 11a,

FIG. 12 shows a bag transporting device according to embodiments of the invention,

FIGS. 13a-b show a loading operation of the dispenser according to embodiments of the invention,

FIGS. 14a-b describe a process of separating the bag to be dispensed from the chain of interconnected bags using a cutting device according to embodiments of the invention,

FIGS. 15a-c describe a process of rejecting a bag to be dispensed,

FIG. 16 shows by way of example a cash handling system comprising four dispensing apparatus as shown in FIG. 1.

### DETAILED DESCRIPTION

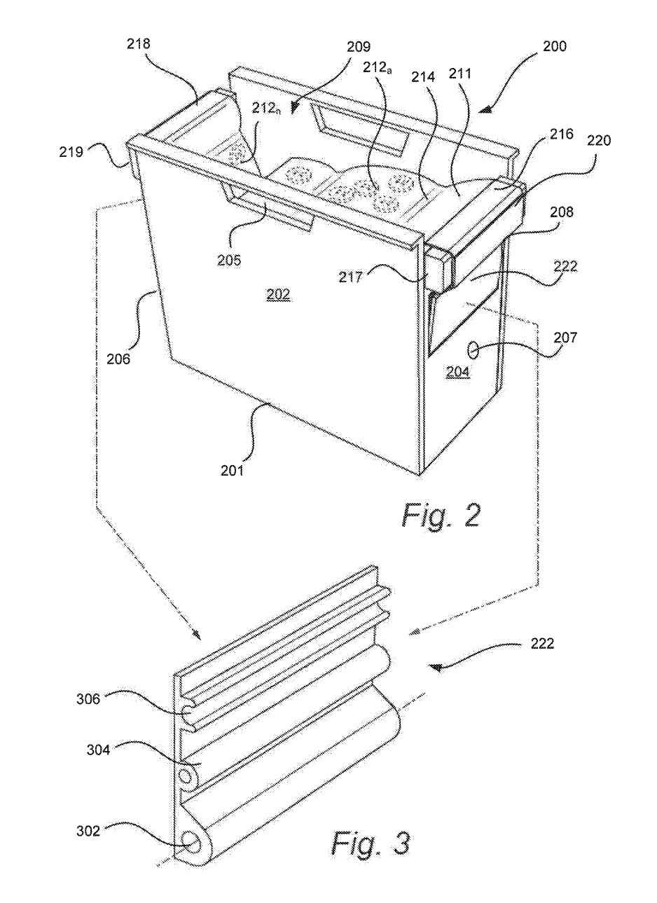

A container for holding a plurality of interconnected bags for coins is disclosed. Such a container 200 can be seen in FIG. 2. The container 200 may be shaped as a rectangular block, with lower part or bottom 201, an upper opening 209, a short side 204 and a long side 202. Further shapes are equally possible, such as a hexagon shape. The container 200 shown in FIG. 2 comprises a bottom side 201 and four sidewalls 202, 204, 206, 208 extending upwardly from the bottom. It may be noted that the four sidewalls 202, 204, 206, 208 according to another embodiment may be formed as a single continuous sidewall with curved corner portions and straight portions between the corners. The container may advantageously comprise a first short side 204, a second short side 206 and two long sides 202, 208.

In the following, the invention will be described in terms of bags of coins, but it should be noted that the invention is not limited to bags containing coins. The invention could be used for bags of other items, such as candy, jewellery, bank-notes or any other item suitable for being enclosed in a bag

The bags of coins contained in the container 200 are interconnected such that all bags of coins 212_{a . . . n} in a container are attached in a long chain 211 of bags. Each bag is sealed by for example heat sealing. Consequently, there is a portion of material 214 between each bag of coins which is not part of any bag, hereinafter called sealing portion 214. This portion 214 may for example be a portion of heat sealed plastic. The ends of the first 212ₐ and the last 212ₙ bag in this row of bags of coins 212 are fixed to the container. The first end 216 is fastened on an outside of a first sidewall 204, e.g. one of the sidewalls of the short side of the container. The second end 218 is fastened on an outside of a second sidewall 206 opposite to the first sidewall. The portions 216, 218 fastened to the sidewalls of the container advantageously consist of material not being part of any bag 212_{a . . . n}, for example the above described sealing portion 214 and according to some embodiments, further non-bag material. Consequently, no coins will be placed outside the sidewalls 204, 206, since the portions fastened on the outside of the sidewalls are not parts of any bag. Moreover, no coin will be placed on the edge of the sidewalls 204, 206 over which the first end 216 and the second end 218 is extending. This is advantageous since the risk of tearing the first 216 or second 218 ends may be reduced. More specifically, the end parts 216, 218 are arranged over press areas 217, 219 and releasably attached to clamping devices 222 on each short side 204, 206. The clamping device 222 will be further described below. Consequently, the container 200 and specifically the clamping device(s) 222 and the press area(s) 217, 219 are adapted for giving firm support for a part of a chain end 216, 218 when such an end is stretched over the press area 217, 219. The press area 217, 219 may be a protruding block as described in FIG. 2. This may facilitate the opening of the clamping device 222 when two containers 200 are pressed towards each other as described below. The dimensions of the press area 217, 219 may be varied in any suitable way. According to other embodiments, the press area 217, 219 may be level with the rest of the short side 204, 206, i.e. not protruding at all. This may simplify the manufacturing process of the container 200.

By employing such clamping devices, the ends of the interconnected chain of coin bags are easily reachable. By stretching the interconnected bags over the edges of the first 204 and second 206 short sides, the stackability of the container 200 may be improved.

Since the weight and the size of coins may vary greatly, the size of a bag of coins may also advantageously vary. In order to allow for ergonomic handling of a container of such bags, the weight of the bags of coins 212_{a . . . n} contained in the container 200 should not be too large. According to some embodiments, the total weight of the container 200 and the bags of coins 212_{a . . . n} contained in the container 200 should not exceed a limit weight, for example 10 kilograms. The limit weight can according to other embodiments be any other suitable value such that 11, 13 or 15 kilograms. The container 200 is advantageously shaped such that it can be carried by a person using only one hand. Consequently, the person can carry two containers 200, one in each hand, for increased ergonomic handling. Consequently, the container 200 should not be too wide. According to some embodiments, the width of the container 200 is within the range of 6-40 centimetres, preferably 10-30 centimetres. The size of the container may typically amount to 40 cm×30 cm×15 cm but these measurements may be varied considerably. What is important is that the weight of a container containing coin bags is not too large for an average person to carry by one hand, for example exceeding 20 kg.

The number of bags of coins 212_{a . . . n} contained in the container may thus be limited by such a weight limit of the container 200. If the container 200 is made out of a light material, such as aluminium or plastic, the number of bags of coins 212_{a . . . n} may be increased. The material of the container 200 should thus advantageously be both light and durable, in order to allow for an increased number of bags of coins 212_{a . . . n} in a single container 200, and in order to be durable against wear out. Using steel as material, these advantages may be achieved. It may be noted that the container 200 can be made of any other suitable material, such as aluminium or any polymer-based material.

Another limit for the number of bags of coins 212_{a . . . n} may be the volume of the container 200. According to some embodiments, the bags of coins 212_{a . . . n} should not reach above the upper boundary of the container 200. According to other embodiments, the bags of coins 212_{a . . . n} can reach above the upper boundary of the container to some extent, as long as a second container could be stacked above the container having the bags of coins 212_{a . . . n} reaching above the upper boundary of the container 200. A feature of the container 200 according to the present invention is that it is stackable. For that reason, any handle(s) of the container 200, used when carrying the container 200 by a user as described above, may be foldable or removable (not shown in the figures). Consequently, when stacking or de-stacking a container, the handles can be retracted or extended accordingly.

The container 200 is designed for easy and safe stacking. For example, the container 200 may be designed such that a locking between a first container and another container stacked above the first container can be achieved. Features facilitating stacking are not shown in the figures.

The bags 212_{a . . . n} for holding the coins may be made of any plastic material such that polypropylene. The bags 212_{a . . . n} are advantageously transparent in order to allow the currency and denomination of the coin contained by a bag to be easily visible.

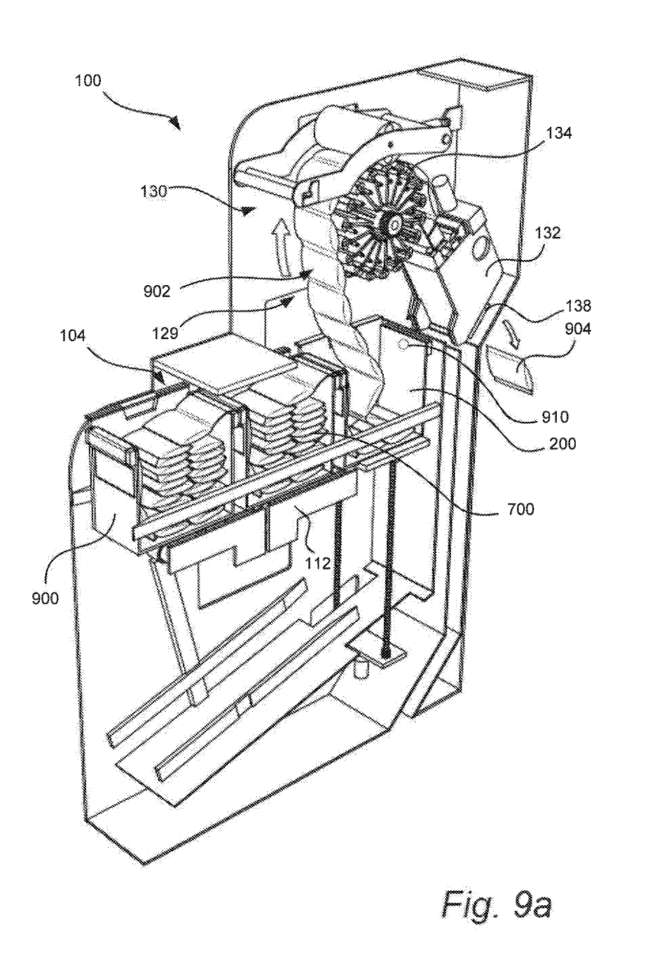

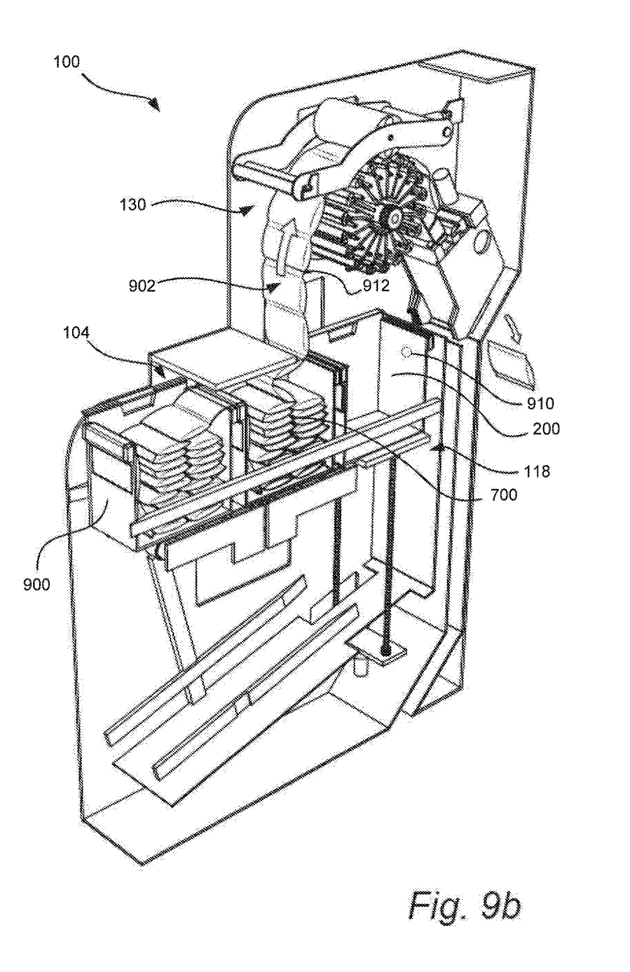

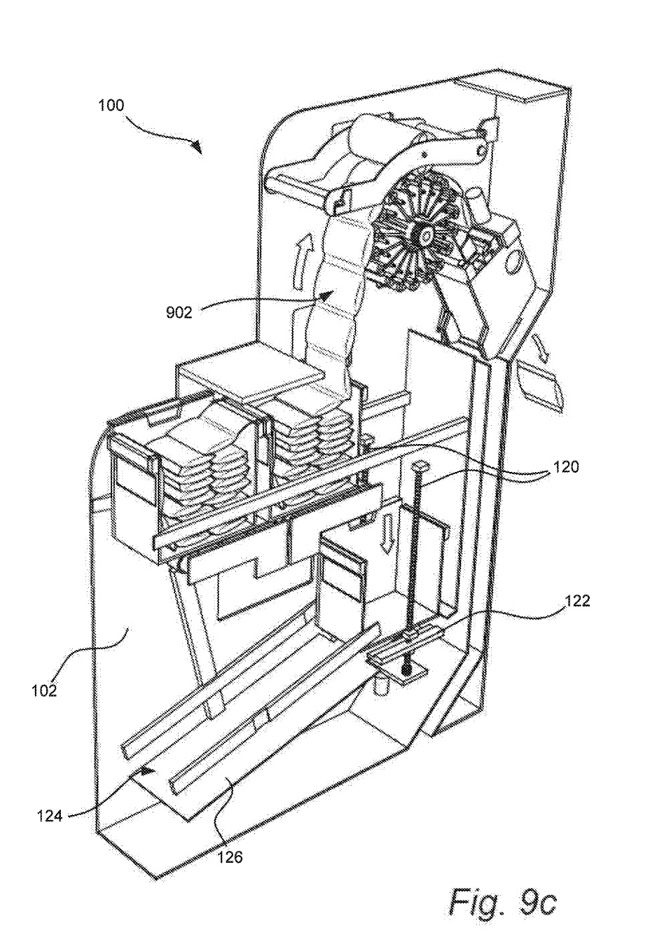

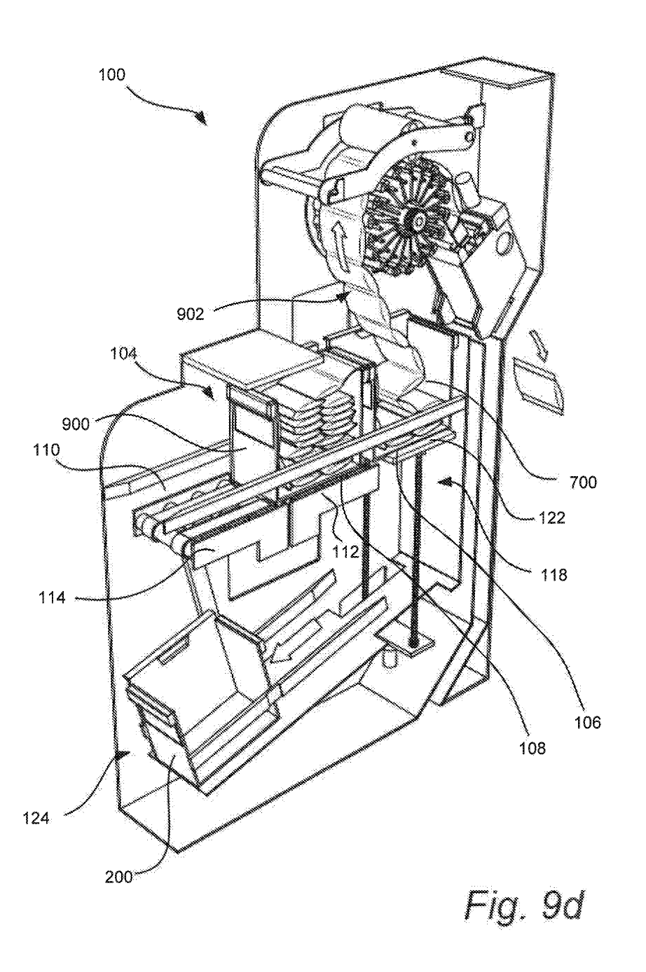

The bags of coins are advantageously put in the container in a zigzag pattern, as visualised for example in FIGS. 9a-d. This may advantageous when removing the bags of coins 212_{a . . . n} from the container 200, for example, when dispensing the bags 212_{a . . . n} through a dispenser. Such a dispenser will be explained in detail below. By placing the bags of coins 212_{a . . . n} in such a zigzag pattern, the risk of entanglement of the chain 211 of bags of coins when dispensing a bag of coins is reduced.

According to embodiments, the first end 216 is fastened on an outside of an upper portion of the first sidewall 204 and the second end 218 is fastened an outside of an upper portion of the second sidewall 206. This reduces the amount of excess material, i.e. material not part of any bag 212_{a . . . n}, which is needed for the first 216 and second 218 ends.

Both the ends 216, 218 may be fastened using a clamping device 222. FIG. 3 shows by way of example a possible design of such a clamping device 222. The clamping device 222 may be fastened by a hinge to the container 200. The clamping device may for example comprise a through hole 302 for a hinge axis provided at the container 200. The hinge is advantageously a self closing hinge such that force is needed to open the clamping device for input of the first 216 and second 218 ends of the interconnected bags 212_{a . . . n}. The tension in the hinge should be large enough such that the clamping device will retain the ends 216, 218 of the interconnected bags 212_{a . . . n} when they are not influenced by external forces, i.e. when the interconnected bags 212_{a . . . n} is just stored in the container 200. The external forces that may act on the interconnected bags 212_{a . . . n} will be described in detail below. The clamping device may further comprise elements 304, 306 which, in addition to the tension of the self closing hinge, will help the clamp to retain the ends 216, 218. These elements may be designed to match corresponding elements (not shown) in the container 200. For example, the bowl-shaped element 306 of the clamping device 222 may be matched by a pipe-shaped element in the container 200 such that the ends 216, 218 may be clamped between the two elements. Similarly, the pipe-shaped element 304 may be matched by a bowl-shaped element in the container 200.

The clamping device 222 may according to some embodiments be opened, or released, by a connected actuating means 207 shown is FIG. 2.

The actuating means may be a mechanical actuating means, e.g. a push button on the surface, in a cavity or on a protruding part of the short side 204, 206 of the container 200. The actuating means 207 may also be electrical, for example a proximity sensor configured to release the clamping device 222 when sensing an object in the vicinity of the sensor. According to embodiments, the actuating means on a first container may be actuated when in contact with a, or being nearby a, corresponding means on a second container. For example, if the actuating means is a button located in a cavity on the first container, the corresponding means on the second container may be a protruding part that will activate (e.g. push) the button on the first container when the first and the second container is pushed together in the correct way.

The first end 216 is provided with a double-adhesive part 220 which is adhering to the first end on the outside of the first short sidewall 204, on a side of the first end 216 which is not touching the first short sidewall 204. Consequently, the double-adhesive part 220 is free to be adhered to an object to which it is pressed against. Such a double-adhesive part may according to embodiment also be located on the outside of the second sidewall 206 on a side of the second end 218 which is not touching the second short sidewall 206. The double-adhesive part 220 is according to embodiments located between an upper edge of the first short sidewall 204 and the clamp 222 holding the first end 216 and additionally or alternatively similarly provided on the second short sidewall 206.

As shown, for example in FIG. 2, the present invention provides a kit for storing and dispensing coin bags, comprising a container 200 as described above, and a chain 211 of a plurality of interconnected coin bags 212a-212n having a first end 216 and a second end 218, said chain 211 being made of a plastic film tube, the tube comprises a plurality of heat-sealed portions 214, wherein each of the plurality of interconnected coin bags 212a-212n is defined by two heat-sealed portions 214. Such a kit provides an improved system for distributing coin bags to end users.

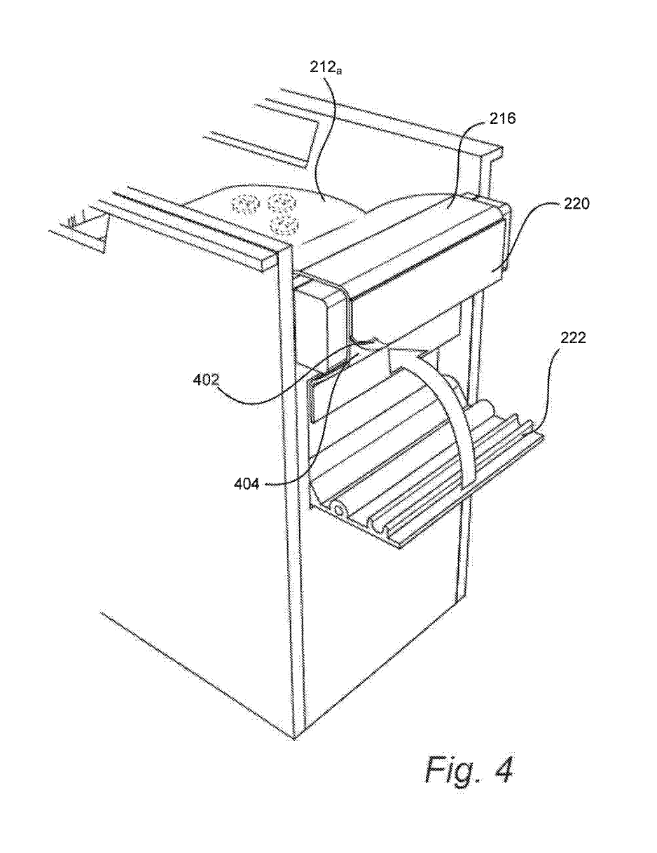

FIG. 4 shows by way of example a fastening procedure of the first end 216 of the interconnected bags 212_{a . . . n} by the clamp 222. As can be seen in FIG. 4, according to some embodiments, the double-adhesive part 220 may comprise a protective film 402 which can be peeled off to uncover an adhesive material 404. The protective film 402 will protect the adhesive material 404, for example when the container 200 is brought from a place to another, or while the container 200 is stored at a safe deposit. The protective film 402 may be part of a larger sealing covering the entire opening of the container 200 as explained below. The first and second ends 216, 218 may be fastened directly after the container 200 has been filled with interconnected bags 212_{a . . . n}, or they may be fastened before placing the container 200 into a dispenser for dispensing the bags.

The first 216 and second 218 end is advantageously fastened equally far from an upper edge of the first 204 and the second 206 sidewall respectively. This may provide a symmetric design of the container 200, which may be advantageously since the filling process and fastening procedure of the container 200 may be more efficient if the direction of the container 200 is of no concern while performing the filling process and fastening procedure.

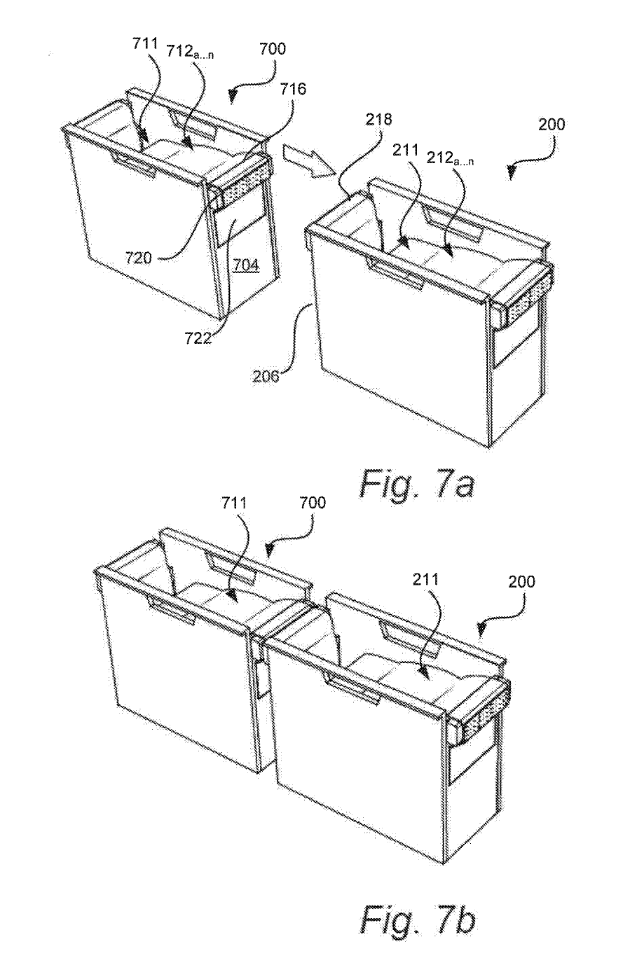

FIGS. 7a-b describe a method for joining two chains 211, 711 of a plurality of interconnected coin bags comprising the plurality of interconnected bags 212_{a . . . n} of a first container 200, for example as described in conjunction with FIG. 2-4 and the plurality of interconnected bags 712_{a . . . n} of a second container 700, for example as described in conjunction with FIG. 2-4. In FIG. 7a, the second container 700 is brought towards, and pressed towards, the first container 200 such that the double-adhesive part 720 of the first end 716 of the plurality of interconnected bags 712_{a . . . n} of the second container 700 is adhering, as shown in FIG. 7b, to the second end 218 of the plurality of interconnected bags 212_{a . . . n} of the first container 200. In other words, the method comprises contacting the second short side 206 of the first container 200 with the first short side 704 of the second container 700, whereby the second end 218 of the chain 211 arranged in the first container 200 is pressed against the first end 716 of the chain 711 arranged in the second container 700, one of these ends being attached to a double-adhesive part, whereby the two chains 211, 711 of a plurality of interconnected coin bags are joined. If the double-adhesive part 716 comprised a protective film, as described above, this film needs to be peeled or otherwise removed before bringing the two containers 200, 700 together. By the method described in FIGS. 7a-b, an uninterrupted chain of bags comprising the plurality of interconnected bags 212_{a . . . n} of the first container 200 and the plurality of interconnected bags 712_{a . . . n} of the second container 700 are formed.

Since the double-adhesive part 720 is located between the upper edge of the first sidewall 704 and the clamp 722 holding the first end 716, the double-adhesive part 720 is fastened on a stretched surface, i.e. on a stretched part of the first end 716, which may improve the adhering between the plurality of interconnected bags 212_{a . . . n} of the first container 200 and the plurality of interconnected bags 712_{a . . . n} of the second container 700. Likewise, the portion of the second end 218 of the interconnected bags 212_{a . . . n} of the first container 200, which may or may not comprise an double-adhesive part of its own, to which the double-adhesive part 720 is adhering, is stretched in the same manner.

In order to improve the releasing functionality of the above described uninterrupted chain of bags, the method may further comprise the step of, after the step of pressing the first sidewall of the second container against the second sidewall of the first container as shown in FIG. 7b, separating the first sidewall 704 of the second container 700 from the second sidewall 206 of the first container 200. As described above, the first and second container 200, 700 may comprise actuation means which releases the clamping device 222 (not shown), 722 when actuated, i.e. when the two containers are pressed towards each other or in vicinity of each other. In other words, the contacting step between the containers 200, 700 causes the actuation means (not shown) of each of the second short side 206 of the first container 200 and the first shirt short side 704 of the second container 700 to release the clamping devices 222 (not shown), 722 of these particular short sides 206, 704.

Since the double-adhesive part 720 should be strong enough to hold the two pluralities of interconnected bags 212_{a . . . n}, 712_{a . . . n}, together, the tacky properties of the double-adhesive part 720 is of importance. The double-adhesive part may for example be made from an adhesive very high bond (VHB) tape manufactured by 3M. Any other adhesive material with enough tacky properties is equally possible, for example a double-sided, pressure sensitive, closed-cell acrylic foam tape.

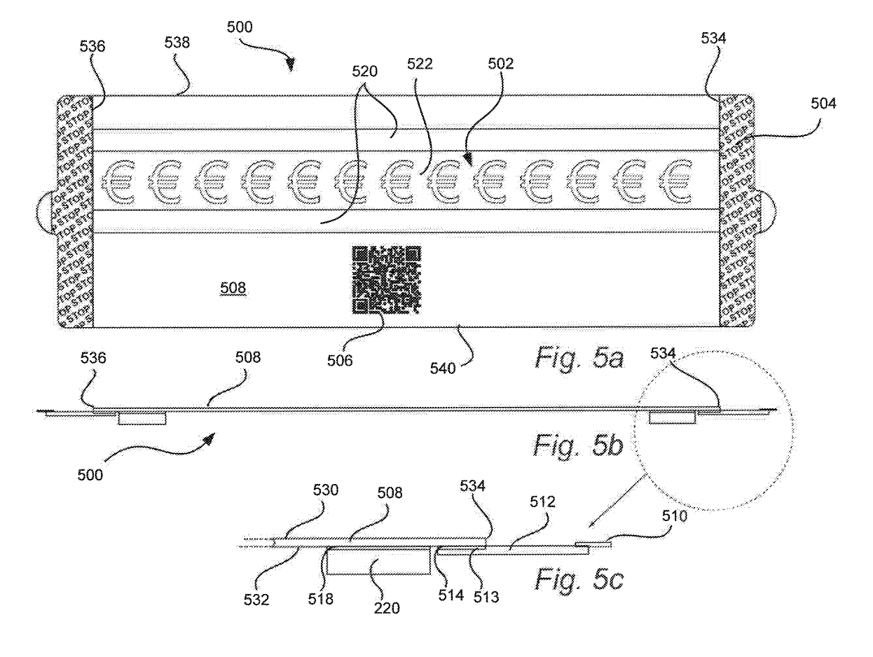

In order to improve security and provide identification of the content of a container, the container may be provided with a sealing. Such a sealing is described by way of example in FIGS. 5a-c. FIG. 5a shows an example of a sealing 500 seen from above, i.e. showing the upper side 508, or information part, of the sealing 500. The information part 508 may have an elongated shape and may comprise a visual identification area 502 which shows information pertaining to the content of a container sealed by the sealing 500. The information part 508 further comprises an upper side 530, a lower side 532, two opposite long sides 538, 540 and two end parts 534, 536 in vicinity of two opposite short sides. In FIG. 5a, the visual identification area 502 comprises an area 522 indicating that the sealing 500 is sealing a container comprising 1 Euro coins. The identification area 502 may further comprise an area 520 which shows information pertaining to the content of a container sealed by the sealing 500 coded as a colour or a pattern. The information part 508 may further comprise a computer readable identification means 506, such as a QR-code 506 or a RFID or any other identification chip.

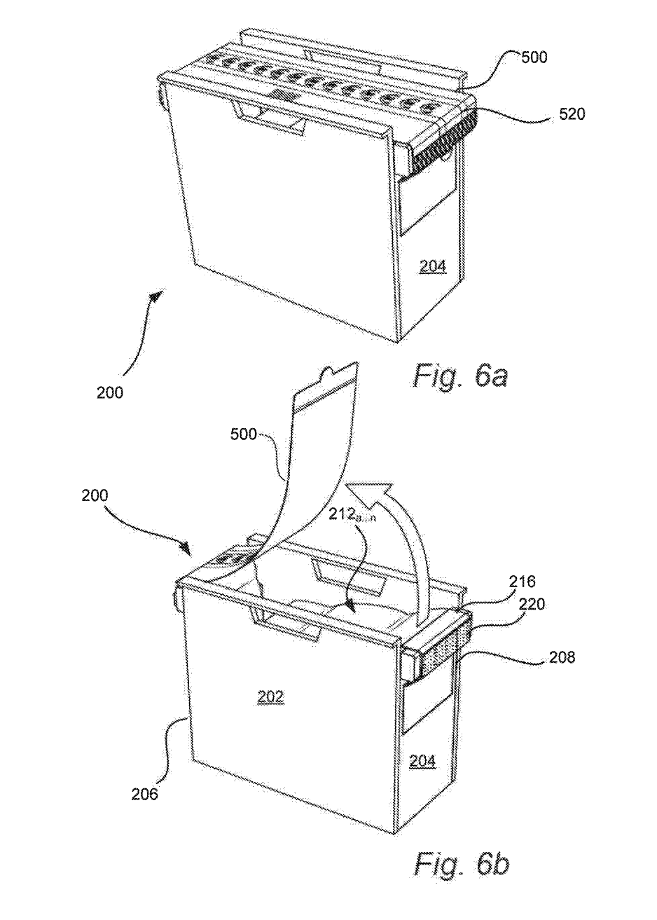

As can be seen in FIG. 6a, the sealing 500 is adapted for covering an opening of the container 200. It may be advantageous if the sealing 500 is placed over the opening of the container such that the area 520 can be seen from the side of the container, as shown in FIG. 6a. This may simplify stocktaking when several containers 200 are stacked above each other. In this case, the area 520 may still be visible for a container stacked underneath another container and indicating the content of the lower container.

FIG. 5b shows the sealing 500 seen from the side, and FIG. 5c shows an enlargement of an end portion of the sealing 500. The sealing 500 comprises a double-adhesive part 220 being adhesive on a top side and a bottom side. The double-adhesive part 220 is positioned at an end portion of the information part 508, on a bottom side of the information part. The sealing further comprises a release liner, or a release layer, 518 positioned between the information part 508 and the double-adhesive part 220, i.e. on the the lower side 532 of an end part 534 of the information part 508. As can be seen in FIG. 6a, the sealing 500 is designed such that when applied to the container 200 for covering the opening of the container 200, the double-adhesive part 220 adheres to an outside of a first sidewall 204 of the container 200. When removed from the container 200, as shown in FIG. 6b, the functionality of the release liner 518 makes the double-adhesive part 220 to stay adhered to the container and thereby providing the first end 216 with an double-adhesive part 220 as described above. In other words, the double-adhesive portion is loosely adhered to said release layer 518 and the surface of the double-adhesive portion 220 facing away from the release layer 518 is adapted for adhering to a chain 211 of a plurality of interconnected coin bags as best seen in FIG. 6b.

As described in FIG. 6a in conjunction with FIGS. 5a-c, the present invention provides a kit for storing and dispensing coin bags which comprises a seal having two end parts 534, 536 and anti-tamper seals 512 having adhesive lower layers 513 at each end part 534, 536 as well as a double-adhesive part 220 in vicinity of at least one of said anti-tamper seals 512. The anti-tamper seals 512 may be adapted for being firmly attached to the one of the short sides 204, 206 of the container 200. According to embodiments, there is a release liner 518 between the double-adhesive part 220 and the seal 500 for easy removal of the seal and such that the double-adhesive part 220 stays adhered to the one of the first 216 and the second 218 end of the chain 211 of interconnected coin bags 212a-212n.

The sealing of the container may be performed with a method comprising three steps. In step one, the kit of parts are provided. Step two comprises arranging the chain 211 of interconnected coin bags 212a-212n in the container 200 in such a way that all of the bags 212ₐ-212n are inside the container, the first end 216 is arranged over the press area 217 and attached by the clamping device 222 of the first short side 204, and that the second end 218 is arranged over the press area 219 and attached by the clamping device 222 of the second short side 206. The third step comprises attaching a seal 500 to the container 200 obtained in step two in such a way that the seal 500 covers the upper opening 209 of the container, whereby the double-adhesive part 220 adheres to one of said first 216 or second 218 ends and anti-tamper seals 512 at each end part 534, 536 adheres to said first and second short sides 204, 206.

Going into more details of the third step, the attaching of the seal 500 to the container 200 may be done in such a way that the seal 500 covers said upper opening 209 of the container 200, the surface of the double-adhesive portion 220 facing away from the release layer 518 of the seal 500 adheres to one of said first 216 or second 218 ends of said chain 211 adjacent to a press area 217, 219, and the adhesive parts 512 at each end part 534, 536 adheres to the first and second short sides 204, 206 of the container 200.

When the containers 200, 700 shown in FIGS. 7a-b are sealed with such a seal 500, the method joining two chains 211, 711 of a plurality of interconnected coin bags 212a-212n, 712a-712n comprises removing the seals 500 of the sealed containers 200,700 thereby also removing the release liners 518 from the double-adhesive parts 220. Thereafter the method continues as shown in FIG. 7b with the step of contacting the second short side 206 of the first container 200 with the first short side 704 of the second container 700, whereby the second end 218 of the chain 211 arranged in the first container is pressed against the first end 716 of the chain 711 arranged in the second container 700, one of these ends being attached to a double-adhesive part, whereby the two chains 211, 711 of a plurality of interconnected coin bags are joined.

In other words, the sealing 500 may be used for covering the opening of a container which comprises a plurality of interconnected bags 212_{a . . . n} for coins. The container 200 may have a bottom and four sidewalls 202, 204, 206, 208 extending upwardly from the bottom. The plurality of interconnected bags 212_{a . . . n} may have a first end 216 and a second end 218, wherein the first end 216 is being fastened on the outside of the first sidewall 204, the second end being fastened on the outside of the second sidewall 206, such that when the sealing 500 is applied to the container 200 for covering the opening of the container and subsequently removed, the first end 216 is provided with an double-adhesive part 220 being the double-adhesive part 220 of the sealing 500. The double-adhesive part 220 provided to the first end 216 is thus located on the outside of the first sidewall 204 on the side of the first end 216 of the plurality of interconnected bags 212_{a . . . n} which is not touching the first sidewall.

As described above, the sealing 500 may further comprise adhesive parts 512 adapted for adhering to the surface of a container. According to some embodiments, the adhesive parts may be anti-tamper seals 512 positioned at each end of the information part. The anti-tamper seal has an adhesive layer 513 and is firmly attached to the main portion 508 by adhesive 514. In case someone has opened the anti-tamper seal 512 by using the finger lift 510, the anti-tamper seal will display some visual information regarding the fact that the seal 512 has been opened, i.e. showing a first appearance when adhered to a surface and a second appearance when having been torn away from the surface. The anti-tamper seal 512 may for example show the word “STOP” as a first appearance, as visualized in FIG. 5a.

As described above, the container 200, which the sealing 500 is covering the opening of, may comprise a plurality of interconnected bags which each contains coins. According to embodiments, the information part 508 may in this case comprise information regarding at least one of the currency of the coins, the denomination of the coins, the number of coins in each bag, the number of bags, and the total number of coins in the container. The area 520 may be color coded depending on at least one of the currency of the coins and the denomination of the coins. The computer readable identification means 506, such as the QR-code 506 or a RFID, may in this case comprise at least portions of the same information.

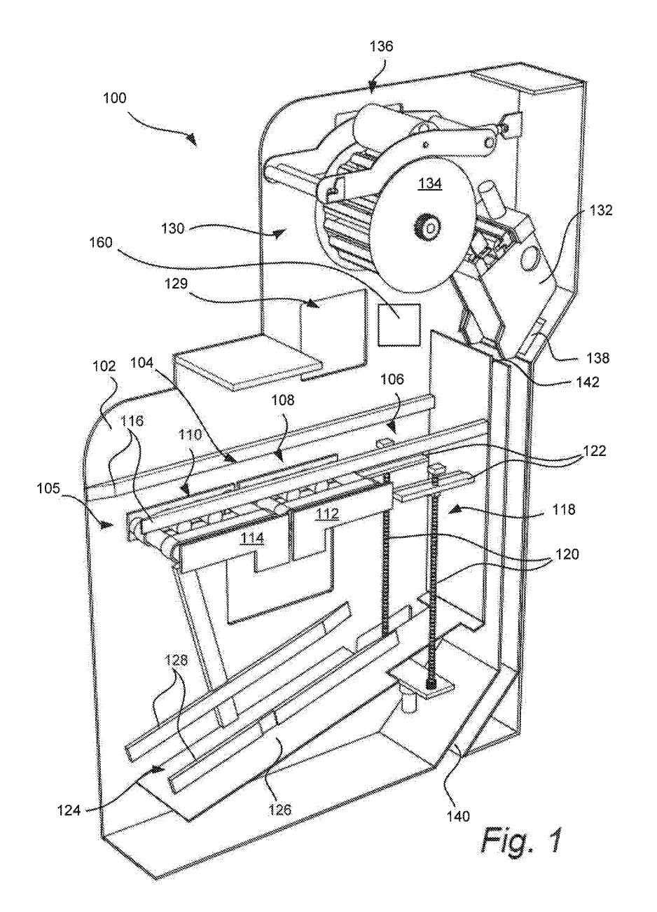

A dispensing apparatus 100 adapted for dispensing a bag for coins will now be described. FIG. 1 shows the dispensing apparatus 100, where parts of a case 102 of the dispensing apparatus 100 have been removed.

The dispenser apparatus comprises a bag storage compartment 104. The bag storage compartment 104 is adapted for storing the bags for coins before they are being dispensed. The bag storage compartment 104 may according to embodiments be adapted for holding container(s) comprising a plurality of interconnected bags for coins, as described above. According to other embodiments, the bag storage compartment may be adapted for storing any suitable container comprising a plurality of interconnected bags for coins.

According to embodiments, the bag storage department 104 is adapted for holding a first container at a first storage position 106, and a second container at a second storage position 108. The bag storage department 104 may further be adapted for holding a third container at a third storage position 110. The bag storage department 104 may according to embodiments be adapted for holding even further containers.

The bag storage compartment 104 in FIG. 1 comprises a first conveyer belt 112 for transporting a container from the second storage position 108 to the first storage position 106. The bag storage compartment 104 may further comprise a second conveyer 114 belt for transporting a container from the third storage position 110 to the second storage position 108. According to embodiments, the bag storage compartment may comprise any other suitable means for transporting a container within the bag storage compartment 104, replacing the conveyer belts 112, 114, such as a container pushing device or pulling device.

The bag storage compartment 104 may further comprise guiding means 116 for guiding a container to a correct position for further handling of the interconnected bags of the container in the dispensing apparatus 100.

The dispensing apparatus 100 further comprises a container removing device 118 adapted to remove a container at the first position 106 from the bag storage department 104. As can be seen in FIG. 1, the container removing device 118 may be an elevator-like device, which in its first position, shown in FIG. 1, is adapted for holding a container at the first storage position 106 in the bag storage compartment 104. The container removing device 118 comprises two container supporting structures 122 and two structures 120 for moving the container supporting structures 122 from and to the first position 106. The two structures 120 may for example be a screw lifting mechanism as shown in FIG. 9c. The container removing device 118 may according to embodiments be implemented such that the supporting structures 122 are moved by compressed air, or by a belt or in any other suitable way. Moreover, according to embodiments, the container removing device 118 comprises only one container supporting structure 122 and one structure 120 for moving the container supporting structure 122 from and to the first position 106. Since the dispensing apparatus is designed such that a container held at the first position 106 cannot tilt, or cannot substantially tilt, one container supporting structure 122 and thus one structure 120 for moving the container supporting structure 122 from and to the first position 106 may be enough. Other ways of implementing the container removing device 118 are left to the skilled person to implement. The functionality of the container removing device 118 will be described in detail further below.

The dispenser apparatus 100 further comprises a container output compartment 124 which is separate from the bag storage compartment. This allows for easy access of a container which has been moved by the container removing device 118 from the first position 106 of the bag storage department 104 to the container output compartment 124. The container output compartment 124 advantageously comprises a declining surface 126 such that a container will be moved by gravity from the container removing device 118 when it is in its second position and holding the container. The second position of the container removing device 118 is when the two container supporting structures 122 has been lowered by the two structures 120 for moving the container supporting structures 122. According to other embodiments, the container output compartment 124 comprises a horizontal belt, such as a conveyer belt, for moving a container from the container removing device 118 when it is in its second position and holding the container. Other ways of implementing the container removing device 118 are left to the skilled person to implement.

The container output compartment 104 may further comprise guiding means 128 for guiding a container down the declining surface 126.

The dispensing apparatus further comprises a bag transporting device 130 for transporting the interconnected bags from a container in the bag storage compartment 104. The bag transporting device 130 comprises a lifting device 134 for lifting the interconnected bags from the bag storage compartment 104 through a transition area 129 located at the interface between the bag storage compartment 104 and the bag transporting device 130. The bag transporting device may further comprise a friction providing device 136.The bag transporting device 130 is adapted to deliver a bag to be dispensed to a cutting device 132 which is adapted for separating the bag to be dispensed from the interconnected bags. The bag transporting device 130 and the cutting device 132 are described in detail below.

The case 102 of the dispensing apparatus 100 comprises a dispense aperture 138 through which the bag to be dispensed is outputted from the dispensing apparatus 100. The case 102 further comprises a reject aperture 142 leading into a reject compartment 140 where a rejected bag is outputted from the dispensing apparatus 100. The dispensing and reject functionality will be described in detail below.

The bag transporting device 130 is thus adapted for guiding the chain 211 of a plurality of interconnected coin bags to the cutting device 132 followed by said dispense aperture 138. The dispensing apparatus 100 further comprises at least one motor (not shown) for driving the various moving parts of the dispensing apparatus, such as the conveyer belt(s) 108, 110, the lifting device 134, the cutting device 132 and the container removing device 118. The at least one motor may according to embodiments be an electric motor. The dispensing apparatus further comprises a control system 160 for controlling different parts of the dispensing apparatus and thus the dispensing process. Generally, the control system 160 is adapted for controlling at least the cutting device 132, first conveyor belt 112, bag transporting device 130, and the container removing device 118. In case additional conveyor belts exist in the dispensing apparatus 100, the control system 160 is adapted for controlling the additional conveyor belts as well.

It may be noted that the control system 160 may be a computer including a screen which may show information to an operator of the dispensing apparatus 100. The screen may according to some embodiments be omitted. The control system 100 may also communicate with the operator using other means such as lamps or sound. The control system 160 may comprise a device adapted to receive user input, such as a keyboard. The control system may or may not have a memory for storing and logging information. In its simplest form, the control system 160 is merely a chip controlling the different motors of the dispensing apparatus 100 depending on input from sensors of the apparatus 100. It may also be noted that the control system can in some embodiments be located separately from the dispensing apparatus 100 and wired or wireless connected to the dispensing apparatus 100.

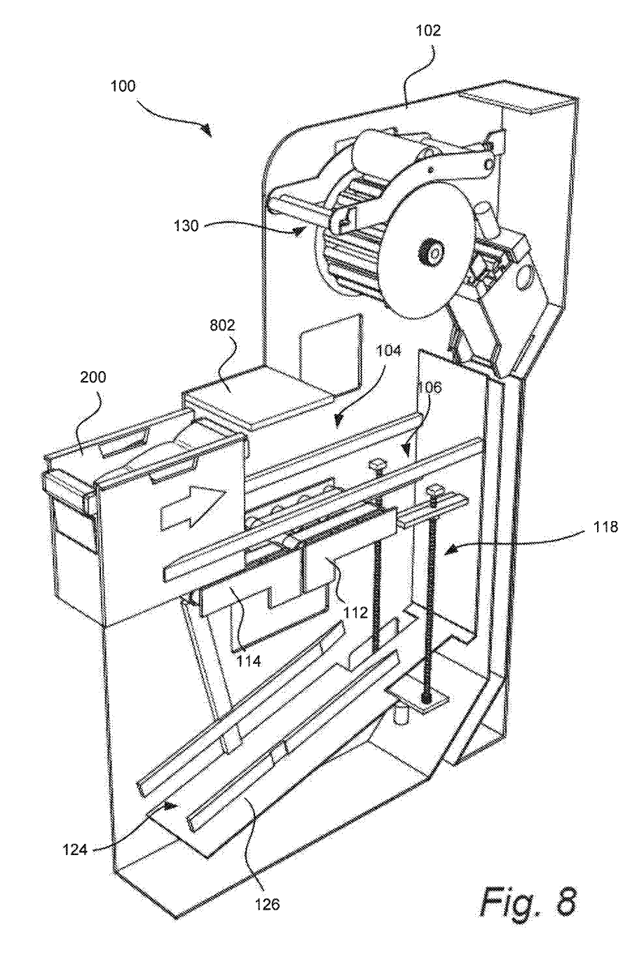

The movement of containers comprising a plurality of interconnected bags for coins in the dispensing process will now be described in conjunction with FIGS. 8, 9a-d and 10.

The bag storage compartment 104 of the dispensing apparatus 100 is adapted to receive a container 200, as shown in FIG. 8. The container 200 is inputted to the dispensing apparatus 100 through an opening of the case 102. Subsequently, the conveyer belt, reference 114 in FIG. 8, closest to the opening may be started for moving the container 200 into the bag storage compartment 104. The opening may be designed such that only a specific type of containers can be used, for example the opening may comprise surfaces complementary to surfaces on the allowed type of container. Moreover, the opening may be designed such that if a handle (not shown) of the allowed type of container is not folded or removed, the container will not be received by the bag storage compartment, for example since the container with unfolded handles does not fit under parts 802 of the case 102 near the opening. In the case the container is not received by the dispensing apparatus 100, the control system 160 may be adapted to warn an operator of the dispensing apparatus 100 that a loading operation of the dispensing apparatus 100 has failed. This warning may be presented to the operator through a computer or by flashing lamps on or nearby the dispensing apparatus 100.

Moreover, the bag storage compartment 104 may not be adapted to receive a container when the container output compartment 124 comprises a container. This may be realized, for example by the control system 160 controlling the motor not to start the conveyer belt 114 when the container 200 is positioned in the opening of the case 102 if a container is present in the container output compartment 124. The user may be notified by the control system 160 as described above. This is advantageous since the dispensing apparatus could malfunction if the container output compartment 124 comprised so many containers such that a container just removed from the first storage position 106 of the bag storage department 104 by the container removing device 118 could not slide down the declining surface 126 and away from the container removing device 118. According to other embodiments, the dispensing apparatus 100 stops if the container output compartment 124 has no room for a further container.

The dispensing apparatus 100 may further comprise means (not shown) for obtaining amount information about the coins and/or coin bags to be dispensed. This means may for example be a QR code reader adapted for reading information on a coin bag or on the information part 508 of a seal 500 of the containers to be received by the apparatus. Further, the means may be a RFID reader adapted for reading information on a coin bag or on the information part 508 of the seal 500 the containers to be received by the apparatus. The means may be a scanner which can be used by the operator of the dispensing apparatus for scanning the QR code or RFID of the seal 500 before removing the seal and putting the container in the dispensing apparatus 100. The means may also be a means for manually entering information such as a key pad. These means are advantageously coupled to the control system 160 of the dispensing apparatus 100.

The dispensing apparatus 100 may further comprise a sensor (not shown) for sensing a number of interconnected bags contained in a container 200 received by the dispensing apparatus. This information may for example be included in an identifier placed on the container 200, for example underneath it. The identifier may thus comprise an identifier comprising information relating to the number of interconnected bags contained in the container 200. The identifier, or information bearer, comprises information pertaining to content of the container such as currency of coins, coin type, amount of coins, amount of coin bags, amount of coins in each coin bag and/or filling address of the container. The information bearer may be a RFID chip or a QR code. The information relating to the number of interconnected bags may be used by the control system 160 of the dispensing apparatus 100, for example for keeping track of when a container is empty since all the bags has been transported from the container by the bag transporting device 130. For this reason, the dispensing apparatus 100 may further comprise a sensor (not shown) for sensing when an interconnected bag is transported from a container in the bag storage compartment 104. This sensor may for example be a camera, wherein the control system 160 comprises algorithms for recognizing when a bag is transported from the container. In case each bag in the container comprises an identifier, for example a QR code, or a RFID, the sensor may be adapted for recognizing this identifier and thus sensing when an interconnected bag is transported from a container in the bag storage compartment 104. According to embodiments, the dispensing apparatus 100 may further be adapted to overwrite the information on the above mentioned identifier placed on the container relating to the number of interconnected bags contained in the container when the bag transporting device 130 is transporting an interconnected bag from the container. This may be advantageous in that it simplifies stocktaking of how many bags are stored in the bag storage compartment 104, without examining each container by counting all bags contained in the container at the given moment. This may further reduce the risk of theft of bags, since the control system 160 as well as the identifier of each container may keep track of the number of bags stored in the container.

The dispensing apparatus 100 and the container 200, as described in conjunction with FIGS. 2-6, adapted to be received by the dispensing apparatus 100 facilitate increased security and decreased risk of theft when handling coins to be dispensed. Since the container 200 is sealed up to the point when it is inserted to the dispensing apparatus 100, and then locked inside the dispensing apparatus 100 wherein the control system 160 as well as the identifier of each container 200 may keep track of the number of bags stored in the container 200 inside the dispensing apparatus, the risk of theft may be dramatically decreased compared to prior art. Moreover, since the container 200 comprises a interconnected chain of bags which in turn is fixed to the container by means of clamping, it is much more difficult to steal a single bag of coins, since each bag in the container 200 is

In the case the bags in the container 200 comprises coins, the identifier placed on the container 200 may further comprise information regarding at least one of the currency of the coins, the denomination of the coins and the number of coins in each bag. The control system 160 may in this case be adapted to not allow a container 200 comprising coins of the wrong currency and/or wrong denomination and/or wrong number of coins in each bag. The operator may be informed if this happens according to above.

When successfully received by the bag storage compartment 104, the dispensing apparatus is adapted to transport the container 200 into the bag storage department 104 and further to the first storage position 106 by means of the conveyer belt(s) 114, 112.

In FIG. 9a, three containers 200, 700, 900 have been received by the dispensing apparatus 100. As described previously, in conjunction with FIGS. 7a-b, the container 200, 700, 900 has been pressed towards each other such that an uninterrupted chain of bags 902 comprising the plurality of interconnected bags of the first container 200, the plurality of interconnected bags of the second container 700 and the plurality of interconnected bags of the third container 900 has been formed. In other words, the first storage position 106 and the second storage position 108 are immediately adjacent to each other in such a way that the second short side 206 of the first container 200 in the first storage position 106 is in contact with the first short side 704 of the second container 700 in the second storage position 108. Further, the second storage position 108 and the third storage position 110 are immediately adjacent to each other in such a way that the second short side 706 of a container 700 in the second storage position 108 is in contact with the first short side of the third container 900 in the third storage position 110. The bag storage compartment 104 is thus adapted for creating and storing an uninterrupted chain 902 of a plurality of interconnected coin bags. In FIG. 9a, the chain 902 comprises the interconnected coin bags contained in the containers 200, 700, 900 at the first, second and third storage position 106, 108, 110. Obviously, in case more or fewer containers are stored in the bag storage compartment 104, the chain 902 comprises the interconnected coin bags from these more or fewer containers. The control system 160 controlling the motor running the conveyer belts is advantageously arranged such that enough pressure for forming the uninterrupted chain of bags 902 is achieved when the container 200, 700, 900 are transported and thus pushed together in the bag storage department 104. In other words, when the bag storage compartment is holding the first container 200 at the first storage position, and the bag storage compartment is receiving a second container 700, the motor is adapted to drive the first conveyer belt 112 such that contact is made between the first and the second containers 200, 700, such that the double-adhesive part of the first end of the plurality of interconnected bags of the second container 700 is adhering to the second end of the plurality of interconnected bags of the first container 200 as described above in conjunction with FIGS. 7a-b. The same goes for the interconnection between the bags of the second container 700 with the bags of the third container 900.

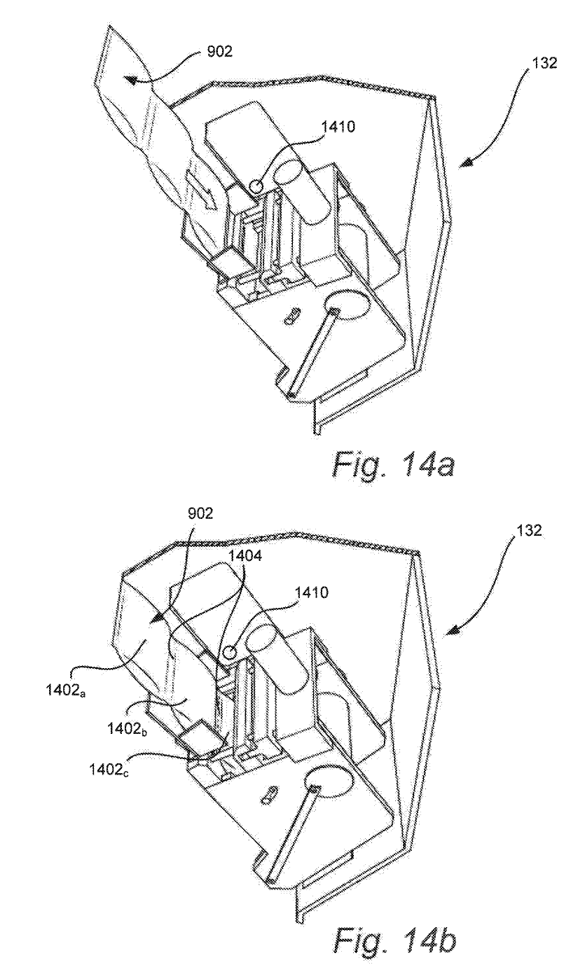

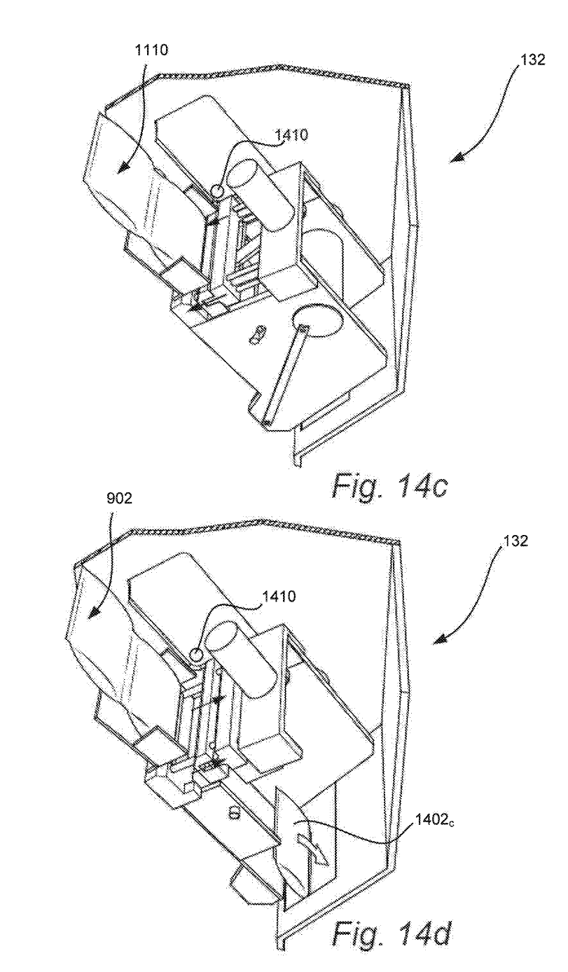

The bag transporting device 130 is adapted for guiding the chain 902 of a plurality of interconnected coin bags from the bag storage compartment 104 to the cutting device 132 followed by said dispense aperture 138. In FIG. 9a, the plurality of interconnected bags of the first container 200 is being transported by the bag transporting device 130 from the first container 200 in the bag storage compartment 104. The bag transporting device 130 comprises a lifting device 134 for guiding the chain 902 over said lifting device 134 and to the cutting device 132 from above so that bags of the chain 902 are drawn into the cutting device 132 by gravity. The cutting device will be further described in conjunction with FIGS. 14a-d. The cutting device 132 has just separated the bag 904 to be dispensed from the chain of interconnected coin bags.

In FIG. 9b, the container 200 has been emptied, i.e. all bags have been transported out from, or away from, the container 200 by the bag transporting device 130. The connection 912, i.e. the bond between the first end of the plurality of interconnected bags of the second container 700 and the second end of the plurality of interconnected bags of the first container 200, is strong enough for holding the two pluralities together. As can be seen in FIG. 9b, the dispensing apparatus 100 may be adapted to continue dispensing bags even though the container at the first storage position is currently empty. In other words, all interconnected bags 212a-212n of the chain originally enclosed in the container 200 have been transported out therefrom. According to embodiments, the dispensing apparatus 100 comprises a sensor for detecting the position of the chain 902 of a plurality of interconnected coin bags 212a-212n in the transition area 129. Consequently it can be determined if the container at the first storage position is empty or not. As best seen in FIGS. 9a and 9b, the position of the chain of coin bags 902 changes when the container 200 is emptied. According to some embodiments, the container 200 comprises a sensor means 910 for detecting the presence of a chain 902 extending through the upper opening 209 (as best seen in FIG. 2) of the container 200. The sensor may be adapted for being connected to an external controller, e.g. the control system 160 of the dispensing apparatus 100, and for keeping track of when the container 200 is empty. The control system 160 thus receives a sensor signal from the container in said first storage position 106, wherein the signal indicating presence of a chain 902 of interconnected coin bags 212a-212n in the container at the first storage position 106. According to other embodiments, the container 200 may be perceived as empty when the connection 912 has been lifted from the area between the first container 200 and the second container 900, as can be seen in FIG. 9b. This may be sensed by means of a camera in the dispensing apparatus, or by any other suitable sensing means.

The control system 160 may thus be adapted for receiving information about the amount of interconnected coin bags 212a-212n of a chain 902 in a container, e.g. the first container 200 in FIG. 9a-b and the second container 700 in FIG. 9d, in the first storage position 106. The control system 160 may be adapted to determining in real time whether there are any interconnected coin bags left in the container in the first storage position 106, and if the control system 160 has determined that there are no remaining interconnected coin bags in the container, the control system 160 is adapted to instruct the container removing device 118 to transfer the container to the output compartment 124.

The control device 160 may thus determine whether there are any interconnected coin bags left in the container based one or more input data. The input data may come from one or more sensors according to what have been described above, for example:

i) information from a scanner reading data from the seal of the container before entered in the dispensing apparatus 100 or from data manually inputted by the operator of the dispensing apparatus 100,

ii) information from a sensor for detecting the position of the chain 902 of a plurality of interconnected coin bags 212a-212n in the transition area 129;

iii) information from the sensor 910 in a container as described above,

iv) information from the cutting device 132 and/or the bag transporting device 130 about the amount of bags that have been transported away from the bag storage compartment 104.

In other words, in FIG. 9b, the control system is aware of that the first container 200 is empty and can thus initiate the process of removing the first container 200 at the first storage position 106 from the bag storage department 104 by means of the container removing device 118. The control system 160 is thus adapted to instruct the container removing device 118 to transfer the container to the output compartment 124. This process is shown in FIG. 9c. As can be seen in FIG. 9c, the dispensing apparatus 100 may be adapted to continue dispensing bags while the process of removing the first container 200 at the first storage position 106 from the bag storage department 104 is ongoing. The two container supporting structures 122 has been lowered from the first position to the second position, as described above in conjunction with FIG. 1, by the two structures 120 for moving the container supporting structures 122. When the container supporting structures 122 are lowered, the container 200 is also lowered and finally it contacts the declining surface 126 of the container output compartment 124. Gravity will thus make the first container 200 to move away from the container supporting structures 122 as can be seen in FIG. 9d.

In FIG. 9d, the first container 200 has moved away from the container supporting structures 122, which in turn have been returned to their first position. As can be seen in FIG. 9d, the first storage position 106 of the bag storage compartment 104 now holds the second container 700 and the second storage position 108 now holds the third container 900. This is due to the fact that the first conveyer belt 112 is adapted to transport the second container 700 from the second storage position 108 to the first storage position 106 subsequent to the removal of the first container 200 by the container removing device 118. Further, the second conveyer belt 114 is adapted to transport the third container 900 from the third storage position 110 to the second storage position 108 subsequent to the removal of the second container 700 from the second storage position 108 by the first conveyor belt 112.

The control system 160 of the dispensing apparatus 100 is thus adapted instruct the dispensing apparatus 100 to remove an empty container from the bag storage compartment and further for instructing the first conveyor belt to forward a container, e.g. the second container 700 in FIG. 9c, in the bag storage compartment 104 to the first storage position 106 in case there is no container in the first storage position 106. The dispenser apparatus 100 thus has room for a further container (not shown) which can be inserted by an operator and received by the bag storage compartment 104. When this further container is received by the bag storage compartment 104, the interconnected bags contained in the further container will adhere to the interconnected bags of the third container 900 as described above. Consequently, the dispensing apparatus 100 is adapted to easily form an uninterrupted chain of bags and further to add on new interconnected bags contained in a further container to the uninterrupted chain of bags.

The dispensing apparatus 100 further comprises an opening (not shown in FIG. 9d) in the case 102 for removing the empty container 200 from the container output compartment 124.

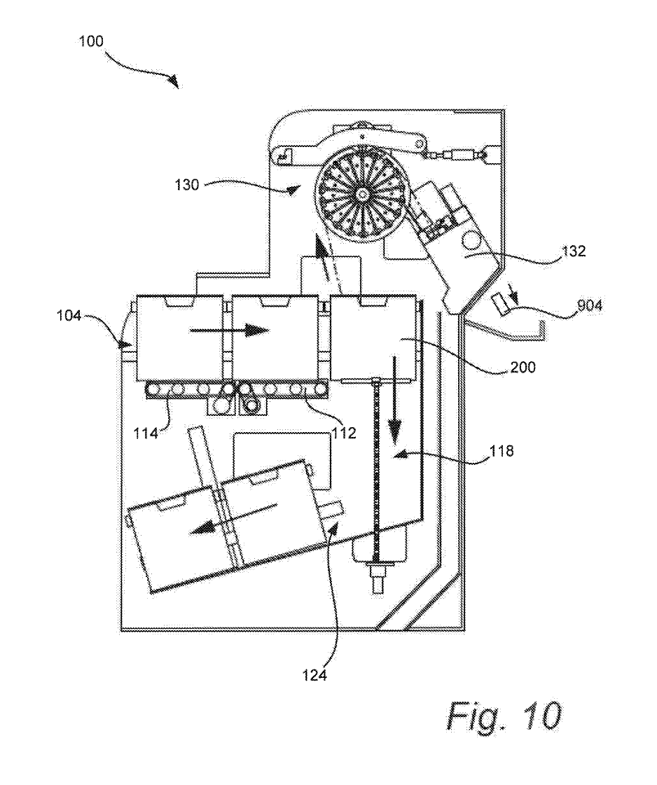

The process of forming, and add on to, an uninterrupted chain of bags, and feeding the chain to the bag transporting device 130 for delivering the bag to be dispensed 904 to the cutting device 132, where it is separated from the uninterrupted chain of bags, is schematically shown in FIG. 10. FIG. 10 further schematically shows how an empty container 200 is removed from the bag storage compartment 104 by the container removing device 118, which transports the empty container to the container output compartment 124 where gravity is used to transport the container away from the container removing device to further be removed from the container output compartment 124 by an operator of the dispensing apparatus 100. FIG. 10 further schematically shows how containers in the bag storage compartment are forwarded by using conveyer belt(s) 112, 114.

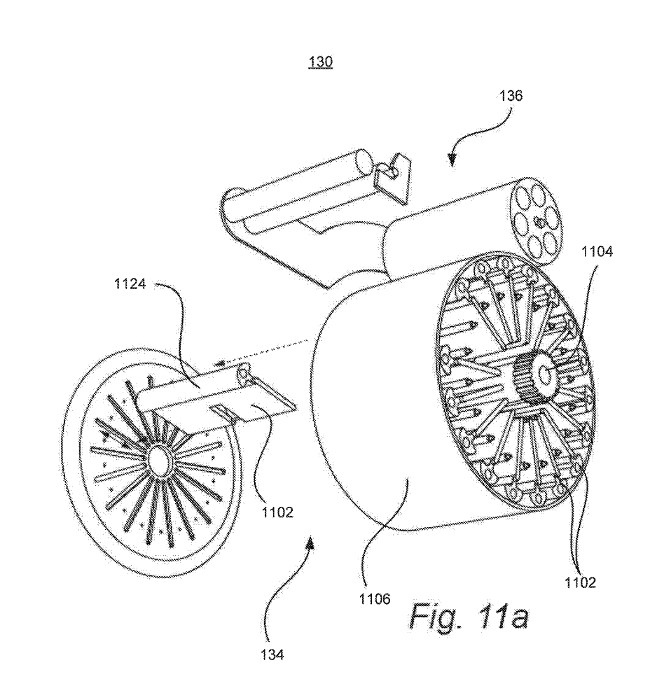

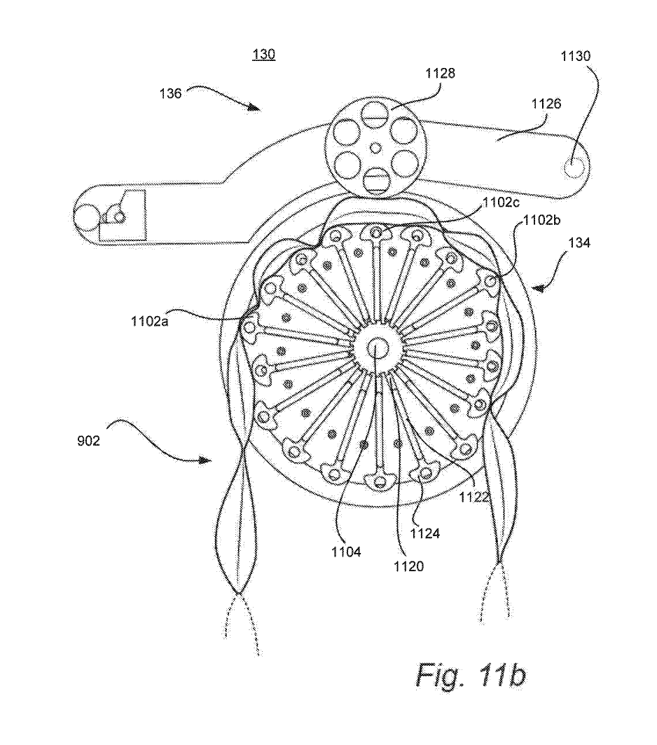

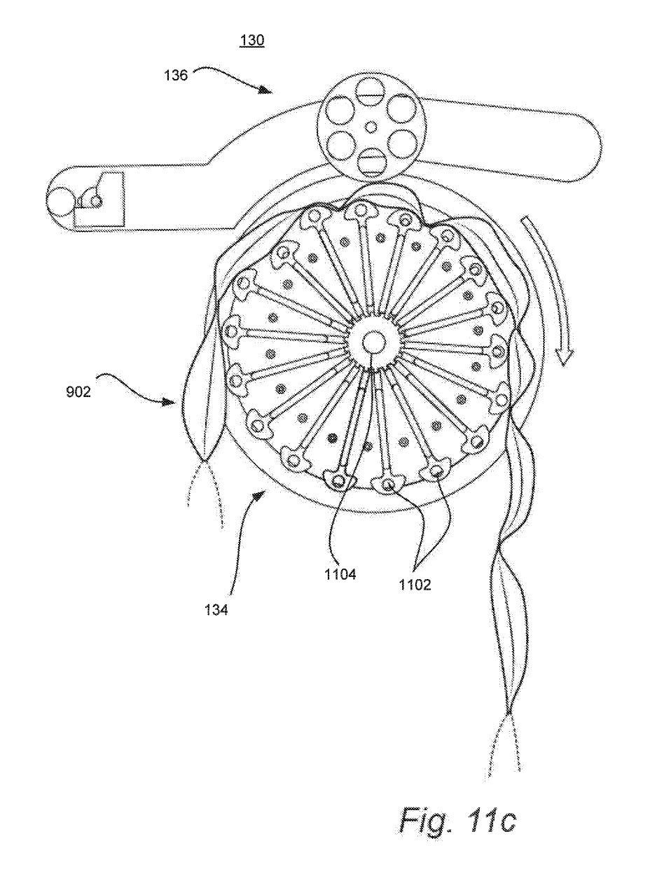

The process of transporting the interconnected bags from the bag storage compartment to the cutting device for separating the bag to be dispensed from the interconnected bags will now be described in detail in conjunction with FIGS. 11-14.

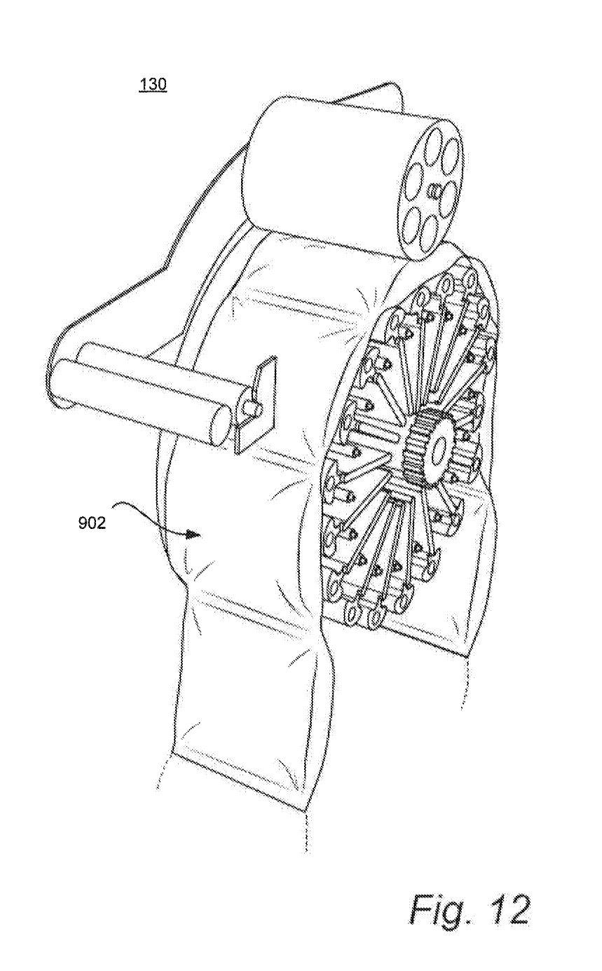

It may be noted that a bag transporting device described in FIGS. 11-12 is just an example embodiment and that other types of bag transporting devices may be used in the dispenser apparatus 100. Moreover, it should be noted that a cutting device described in FIGS. 14a-d may be used in the dispenser apparatus 100 with a different bag transporting device than the one described in FIGS. 11-12. Further, it may be noted that a different cutting device than the one described in FIGS. 14a-d may be employed in the dispenser apparatus 100. The different parts of the dispenser apparatus 100 and processes described in the FIGS. 1-15 may thus be seen as separate inventions which may or may not be used in an apparatus for dispensing bags for coins.

FIG. 11a shows by way of example a bag transporting device 130 for transporting interconnected bags from the bag storage compartment 104 described above. The bag transporting device 130 comprises a lifting device 134 for lifting the interconnected bags from the bag storage compartment. Optionally, the bag transporting device 130 may comprise a friction providing device 136. The lifting device 130 is according to an embodiment wheel shaped, and adapted to rotate around a center 1104 of the wheel. According to other embodiments, the lifting device may be shaped as an oval, a triangle, a hexagon or any other suitable shape.

The lifting device is powered and arranged at a higher level than the cutting device 132, such that it can deliver the bag to be dispensed from above, which will be described in conjunction with FIGS. 14a-d below. Moreover, the lifting device 134 is adapted to conform to shapes of bags of a chain of a plurality of interconnected coin bags in contact with the lifting device 134 in order to exert a pulling force on the chain 902 out of the bag storage compartment. For this reason, the lifting device 134 comprises movable parts 1102 arranged to move in a direction towards the center 1104 of the lifting device 134. The movable parts 1102 are thus arranged to move radially back and forth in conformation to shapes of the chain 902. Each movable part may thus move from an outer position, furthest away from the center, or axis, 1104 of the lifting device, and all the way to an inner position, closes to the center of the lifting device. Each movable part may be a spring-suspended spoke and will thus be in its outer position when no weight, i.e. bag, is in contact with it. Consequently, the area 1106 of the lifting wheel, which during operation may be in contact with the interconnected bags for coins, is flexible in a radial direction and may thus conform to the shape of each bag. Since, as described above and will be further described in conjunction with FIGS. 11b-c, each bag may have a different shape compared to the other bags, and the movable parts 1102 improves the ability of the lifting device 134 to exert a pulling force on the interconnected bags out from the bag storage compartment which in turn increases a lifting ability of the lifting device 134. The number of movable parts 1102 in the lifting device 134 is optional and depends on the possible sizes of the bags as will be understood from the below.

The lifting device 134 may optionally comprise a flexible outer belt 1106, tightly wrapped around the movable parts 1102. In other words, the lifting device 134 may comprise a cover material 1106 covering a contact surface between the lifting device 134 and the interconnected bags when lifting the interconnected bags from the bag storage compartment. In yet other words, the lifting device 134 further comprises a cover material 1106 in communication with the movable parts 1102 and adapted for being in communication with a chain 902 of a plurality of interconnected coin bags. The flexible belt 1106 is thus covering the outer edges of the movable parts 1102 and is advantageously made out of a high friction material, such as a high friction rubber material, to further improve the pulling force exerted on the interconnected bags out from the bag storage compartment. The flexible outer belt 1106, i.e. the cover material 1106, may thus increase the friction between the lifting device and bags in contact with the lifting device. The flexible properties of the belt 1106 may ensure that the belt will move along with the movable parts 1102 towards the center 1104 of the lifting device 134 when in contact with a bag. According to other embodiments, an outer part 1124 of each movable part 1102 comprises a separate portion of such a cover material 1106.

FIG. 11b shows the bag transporting device 130 in the process of transporting a chain of interconnected bags 902. Going into details of an exemplary embodiment of the movable parts 1102, each movable part, or spoke, 1102 may comprise a spring part 1120 connected to the center, or axis, 1104, an inner part 1122 connected the spring part 1122, and the outer part 1124 connected to the inner part 1122. As can be seen in the figure, the lifting device 134 is adapted to conform to shapes of bags in contact with the lifting device since the movable parts 1102 will are arranged to move in a direction towards the center, or axis, 1104 of the lifting device and may thus exert a pulling force on the bags. For example, the movable parts 1102a, 1102b which are in contact with parts of the bags that not contains coins or very little coins will be closer to their outer position and this exert a pulling force on the chain of interconnected bags 902. Moreover, since the direction towards the center 1104 for each movable part 1102 is substantially perpendicular to the transporting direction of a bag in contact with the movable part, the pulling force may be further increased. It may also be noted how the semi-circular portion of outer tip of each outer part 1124, for example of the movable parts 1102a-c, provides a smooth contact surface between the movable parts and the chain of bags 902. Each movable part 1102 may thus according to embodiment comprises a semi-circular portion 1124 extending along the contact surface between the moving part 1102 and the interconnected bags. The risk of tearing or otherwise damaging a bag in contact with the lifting device may thus be reduced.

Moreover, the functionality of the friction providing device 136 may be seen in FIG. 11b. The friction providing device 136 is adapted to push a bag transported by the lifting device 134 towards the lifting device 134 and thus increase the friction between the lifting device 134 and the chain of bags 902. The friction providing device 136 comprises a wheel 1128 acting as a counterpart to the lifting device.

Moreover, the friction providing device may according to embodiments be used for checking the thickness of bags lifted by the lifting device 134. The max size that the dispenser apparatus 100 can handle is predetermined in the distance between the friction providing device 136 and the closest moving part 1102c in its inner position. In case a larger bag is transported by the bag transporting device 130, the dispenser apparatus 100 may be stopped. Alternatively or additionally, in case such a larger bag is transported by the bag transporting device 130, the operator of the dispenser apparatus may be notified and warned according to above. According to embodiments, the sensor 1130, connected to the control system 160, is configured for measuring the angle of a pivotable arm 1126, wherein an angle value above a certain value, i.e. when a too large bag is transported by the bag transporting device 130, induces the control system 160 to interrupt dispensing of coin bags and/or to warn the operator.

FIG. 11c shows how the wheel shaped lifting device 134 is adapted for lifting the chain of interconnected bags 902 from the bag storage compartment (not shown)and delivering the bag to be dispensed (not shown) to the cutting device (not shown) by rotation of the wheel shaped lifting device 134.

FIG. 12 shows a 3d view of the bag transporting device 130 in the process of transporting the chain of interconnected bags 902.

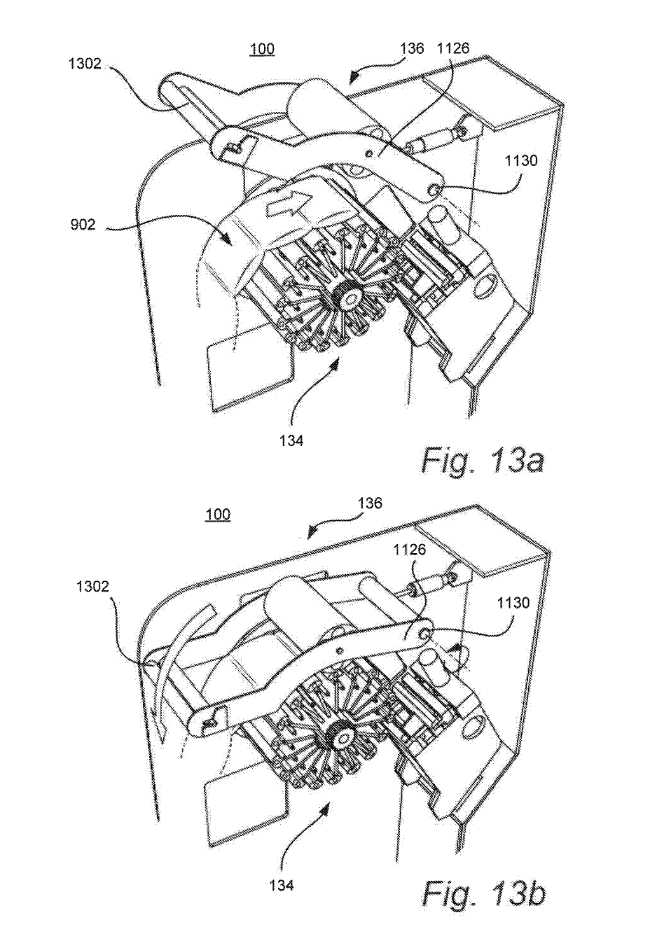

FIGS. 13a-b show an embodiment of a loading operation of the dispenser apparatus 100. According to this embodiment, the friction providing device 136 may be folded away from, or tilted away from, the lifting device 134 using a handle 1302. According to other embodiments, the folding operation of the friction providing device may be controlled by the control system 160 of the dispenser apparatus 100. When folded away, an operator of the dispenser apparatus 100 can insert the interconnected bags 1100 over the lifting device 134 and under the friction providing device 136. The dispenser apparatus 100, or the friction providing device 136 itself, may comprise a sensor 1130 that senses if the friction providing device 136 has been lifted away, i.e. folded, from the lifting device. The control system 160 may then be adapted, using the information from the sensor 1130, such that the dispenser apparatus 100 cannot be started or that it is stopped if it already is running. According to embodiments, the sensor 1130, connected to the control system 160, is configured for measuring the angle of the pivotable arm 1126, wherein an angle value above a certain value, i.e. when the pivotable arm is folded away from the bag transporting device, induces the control system 160 to interrupt dispensing of coin bags. According to other embodiments, the sensor 1130 is a simple mechanical or electronic on/off switch which is turned on or off at a certain angle and connected to the control system 160 as described above.

In FIG. 13b, the friction providing device 136 is folded towards the lifting device 134 again. The sensor may then tell the control system 160 that the dispenser apparatus 100 is loaded, and the control system 160 may then allow the dispenser apparatus 100 to be used for dispensing bags.

The dispenser apparatus may additionally or alternatively comprise a sensor (not shown) for sensing that bags are in contact with the lifting device, and the control system 160 may be adapted such that the dispenser apparatus 100 cannot be started if this is not the case.

FIGS. 14a-d show by way of example the cutting process in the dispensing apparatus 100. As can be seen in FIG. 14a, the interconnected bags 1100 are advantageously delivered to the cutting device 132 from above the cutting device 132. Consequently, gravity helps in the delivery. The control system 160 of the dispensing apparatus 100 is advantageously adapted to deliver one bag at the time to the cutting device 132 for separation from the chain of interconnected bags 902. According to other embodiments, several bags may be delivered to the cutting device for separation from the chain of interconnected bags 902.

As described above, each bag of the chain of interconnected bags 902 may be defined by a sealing portion 1404 on each side of the bag 1402ₐ This is shown in FIG. 14b. The cutting device 132 may comprise a sensor 1410 adapted to sense a position of a content of a bag 1402_{b} interconnected to the bag 1402_{c} to be dispensed. Since the bag 1402_{c} to be dispensed is delivered from above the cutting device 132, so is the bag 1402_{b} interconnected to the bag 1402_{c} to be dispensed. Consequently, the content of the bag 1402_{b} will accumulate in a lower part of the bag 1402_{b}. The position of this lower part of the bag 1402_{b} will thus be sensed by the sensor 1410. In case the content of the bag 1402_{b} interconnected to the bag 1402_{c} to be dispensed is metallic, the sensor 1410 may be an inductive sensor 1410. According to other embodiments, a camera may be used as the sensor 1410, and image analysis can be used for sensing the position of the content of the bag 1402_{b} interconnected to the bag to be dispensed 1402_{c}.

The position sensed by the sensor may then be used by the control system 160 controlling the cutting device 132 for determining a cutting position such that the cutting device separates the bag to be dispensed 1402_{c} at the sealing portion 1404 between the bag 1402_{c} to be dispensed and the bag 1402_{b} interconnected to the bag 1402_{c} to be dispensed using the sensed position of the content.

In other words, the sensor 1410 is adapted to detect positions of content of bags in a chain 902 of a plurality of interconnected coin bags and to forward data corresponding to the positions to the control system 160. The control system 160 is adapted to calculate whether said chain 902 has been fed into a position where a coin bag 1402c could be cut off from the chain. If that is the case, the control system is adapted to instruct the cutting device 132 to cut off the coin bag 1402c which can be seen in FIG. 14c.

FIG. 14c describe how the cutting device 132 is separating the bag to be dispensed (not shown) from the chain of interconnected bags 902. The cutting device 132 comprises a cutting blade (not shown) which the cutting device 132 is adapted to push against the determined cutting position. According to embodiments, the cutting blade is further adapted to cut a slit in the sealing portion of the separated bag to facilitate opening of the separated bag 1402_{c}. The slit may be perpendicular to the end of the sealing portion where the cutting blade just separated the bag to be dispensed from the chain of interconnected bags 902. FIG. 14d shows how the cutting blade is retracted from the chain of interconnected bags 902 when the separation of the bag 1402_{c} to be dispensed is completed.

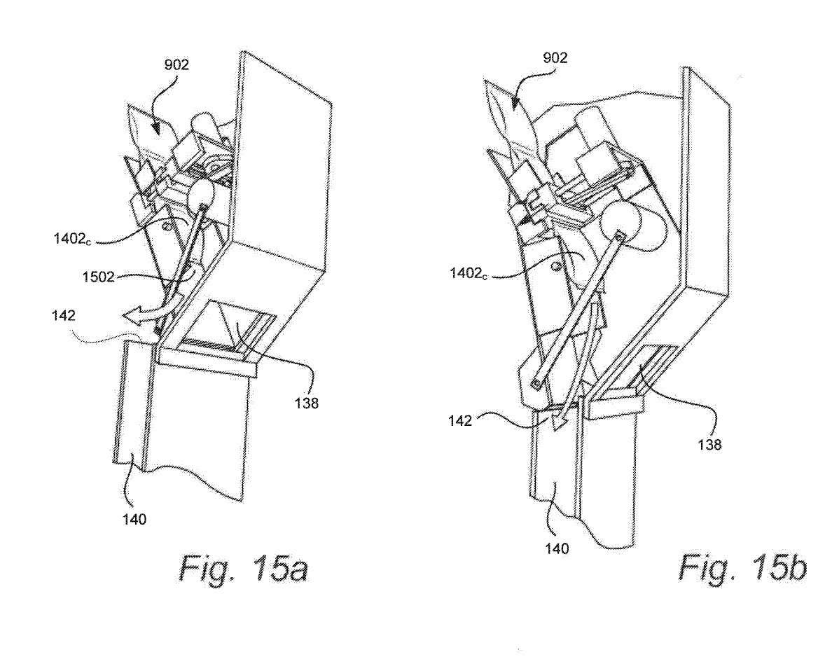

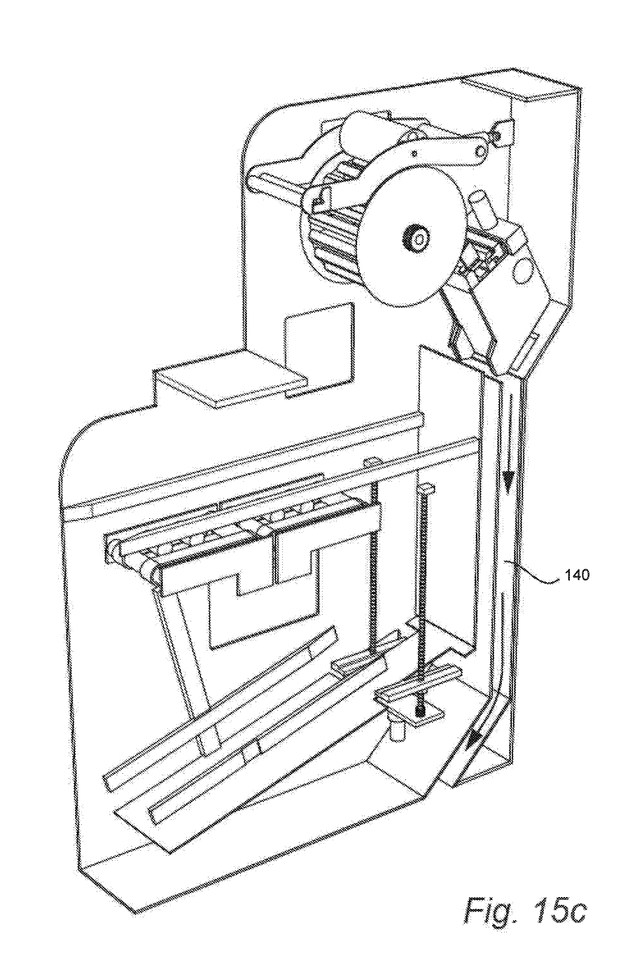

In case the separation fails, i.e. the bag 1402_{c} to be dispensed is not separated from the interconnected bags 902, the cutting device may be adapted to retry to separate the bag 1402_{c} to be dispensed a threshold number of times. The threshold may be 1, 2, 5 or any suitable number. This means that the process shown in FIGS. 14c-d is redone e.g. 5 times. In case the bag 1402_{c} to be dispensed is still connected with the chain of interconnected bags 902, the dispensing apparatus may change from a dispense mode to a reject mode. This is shown in FIGS. 15a-b.

In FIG. 15a, the bag 1402_{c} to be dispensed is not separated from the chain of interconnected bags 902. According to embodiments, the cutting device comprises a reject sensor 1502, which in one embodiments is a pressure sensor, located just below the cutting blade that senses that the bag 1402_{c} to be dispensed has not been separated from the chain of interconnected bags 902 since the bag 1402_{c} is still putting pressure against it. The reject sensor 1502 may be any suitable type of sensor, for example an inductive sensor sensing the content in the not separated bag 1402_{c}. The reject sensor may also be provided in the cutting blade of the cutting device, and configured to sense if the cut did not succeed, for example by sensing the position of the tip of the cutting blade. The reject sensor 1502 is according to embodiments adapted for sending a signal to the control system 160 when the cutting device has failed to cut off a coin bag from said chain 902. When the reject sensor 1502 senses that a separation failed, i.e. when the cutting device 132 has failed to cut off the coin bag to be dispensed from the chain 902 of interconnected coin bags, the control system 160 is configured to open a reject aperture 142 upon receipt of the above described signal from the reject sensor 1502. It may be noted that the control system 160 may be configured to open the reject aperture 142 only after above described threshold amount of attempts. The opening of the reject aperture 142 is shown in FIG. 15b. The reject aperture 142 is adapted to open and close the reject compartment 140. The dispensing apparatus is thus put in the reject mode. This means that the bag will not fall through the dispense aperture 138 and to be dispensed but instead will fall through the reject aperture 142 and into the reject compartment 140 and to be rejected. The reject compartment 140 if further shown in FIG. 15c. The rejected bag(s) may be collected by a box beneath the exit of the reject compartment 140. The reject aperture 142 is further adapted to be closed after the bag to be dispensed 1402_{c} have been separated from the interconnected bags by the cutting device when the dispenser is in a reject mode

When in the reject mode, since the bag 1402_{c} to be dispensed was not separated, despite several attempts by the cutting device, the dispensing apparatus is adapted to feed forward another bag, e.g. the bag 1402_{b} (shown in FIG. 14b) interconnected to the bag 1402_{c} to be dispensed. The cutting device 132 is then adapted to try to separate these two bags from the chain of interconnected bags 902. This procedure is repeated until the cutting device successfully separates the bags to be rejected. When this is done, the reject aperture 142 is adapted to be closed and the dispensing apparatus 100 will yet again be in the dispense mode. The number of rejected bags may be logged by the control system 160.

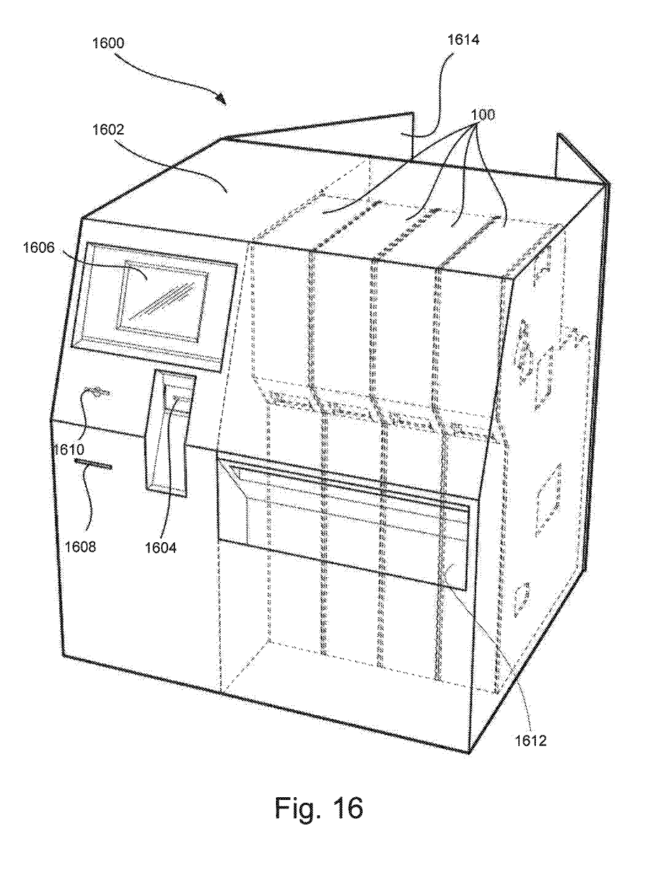

FIG. 16 shows by way of example a cash handling system 1600. The cash handling system 1600 may comprise a plurality of dispensing apparatuses 100. According to some embodiment, the cash handling system 1600 comprises four dispensing apparatuses 100. According to other embodiments, the cash handling system 1600 may comprise other numbers of dispensing apparatuses 100 such as 1, 2, 6 or 8. When handling the Euro currency, it may be advantageously if the number of dispensing apparatuses 100 is eight, one for each denomination of coins that exist for the Euro currency. The cash handling system in FIG. 16 further comprises a cash and banknote handling unit 1602. According to some embodiments, the cash and banknote handling unit 1602 comprises means 1606 for controlling the cash handling system 1600, for example a pressure sensitive display 1606. According to other embodiment, the cash and banknote handling unit 1600 comprises other types of input means such as a keyboard or soft keys on the side of the display 1606. The cash and banknote handling unit 1602 may further have means 1604 for inserting a credit card and means 1604 for input of bank notes. The cash and banknote handling unit 1602 may further have means 1608 for output of bank notes. The cash and banknote handling unit 1602 may further comprise means (not shown) for input and/or output of loose coins. A user of the cash handling system 1600 may receive a receipt of a performed cash withdrawal/deposition/exchange operation through a receipt printer 1610. According to embodiments, the cash and banknote handling unit 1602 comprises means for handling credit card and/or means for handling coins and/or means for handling notes according to above. The cash handling system 1600 may thus support at least one of the following exchange options:
Credit card to coin bags
Bank notes to coin bags
Coins to coin bags
Coins to bank notes
Coins to coins
Bank notes to bank notes
Credit card to coins
Credit card to bank notes.

A user of the cash handling system 1600 may receive coin bags from the dispensing apparatuses 100 through an aperture 1612 of the housing of the cash handling system 1600. Moreover, an operator of the cash handling system 1600 may reach the dispensing apparatuses 100 and the cash and banknote handling unit 1602 thorough doors 1614 on a rear side of the cash handling system 1600. The operator may for example input a container comprising interconnected coin bags as described above into the dispensing apparatuses 100, or refill or empty the cash and banknote handling unit 1602. The rear side of the cash handling system 1600 may also comprise a user interface (not shown) for controlling the cash handling system 1600, for example a touch sensitive display or any other suitable user interfaces. The cash handling system 1600 may further comprise a control system (not shown) controlling all the separate units 100, 1602. The control system may thus be connected to the control systems 160 of the dispensing apparatuses 100 and a similar control system of the cash and bank note handling unit 1602. The rear side is usually no reachable for a regular user of the cash handling system 1600, e.g. a cashier that want to exchange bank notes for coin bags.

The overall process of producing bags of coins and deliver these to a dispenser for further dispensing of each bag to an end consumer such as a cashier in a warehouse may be as in the following.

The process of filling each bag that can be done with standardized volumes and types of coins in each bag or bags that are filled according to customer requirements, both with several denominations in each bag and varied number of coins. The content of each bag may be recorded in a server. The process of filling each bag may be linked to a unique RFID code that is located on the container and stored on the server. This data can be retrieved later from the server, for example when the container is entered in the dispensing apparatus. Consequently it can be verified that the correct customer gets the each container.

By having a RFID chip on each container may make it possible to enter information directly on the chip during the filling process and then make this information available during distribution or storage to easily identify the contents or stock location without having access to the server.

Each bag can be provided with a barcode or QRC which makes it possible to track every bag from production until it have been distributed to the end user, the code can be stored in the server and/or on the RFID chip of the container. It may thus be very easy to follow up what has been delivered and also identify if there is a loss while the container is delivered to the dispenser apparatus. A reader of the barcode or QRC may be available in the filling machine and the dispenser apparatus.

With these solutions, it is easy for the person responsible for the distribution to monitor the delivery via the server.

1. A dispensing apparatus for dispensing coin bags, the dispensing apparatus comprising:
a dispense aperture through which coin bags are dispensed;
a cutting device for cutting of a coin bag from a chain of a plurality of interconnected coin bags
a bag storage compartment adapted for receiving a first and a second container, each containing a chain of a plurality of interconnected coin bags,
the bag storage compartment having a first storage position and a second storage position,
the bag storage compartment further comprising a first conveyor belt for transporting a container in the second storage position to the first storage position,
a bag transporting device adapted for guiding the chain of a plurality of interconnected coin bags to said cutting device followed by said dispense aperture,
a transition area located at the interface between the bag storage compartment and the bag transporting device,
an output compartment for receiving and putting out empty containers,
wherein the dispensing apparatus further comprises a container removing device, wherein the container removing device is adapted for holding the first container at the first storage position while the plurality of interconnected coin bags in the first container is transported out from the first container by the bag transporting device, wherein the container removing device is further adapted for transferring the first container at the first storage position to the output compartment when all interconnected coin bags of the chain originally enclosed therein have been transported out therefrom, and
wherein the first conveyor beltis adapted for transporting the second container from the second storage position to the first storage position subsequent to the removal of the first container by the container removing device.

2. The dispensing apparatus of claim 1, wherein the output compartment includes a declining surface and container removing device is adapted for transferring the first containerto the declining surface.

3. The dispensing apparatus of claim 1, wherein the bag storage compartment also comprises a third storage position for receiving a third container, and a second conveyor belt adapted for transporting the third container from the third storage position to the second storage position subsequent to the removal of the second container) from the second storage position by the first conveyor belt.

4. The dispensing apparatus of claim 1, wherein the first storage position and the second storage position are immediately adjacent to each other in such a way that a second short side of the first container in the first storage position is in contact with a short side of the second container in the second storage position.

5. The dispensing apparatus of claim 3, wherein the second storage position and the third storage position are immediately adjacent to each other in such a way that a second short side of the second container in the second storage position is in contact with the first short side of the third container in the third storage position.

6. The dispensing apparatus according to claim 1, further comprising a means for counting the amount of coin bags that has been transferred from the storage compartment.

7. The dispensing apparatus according to claim 6, further comprising a means for obtaining amount information about the coins and/or coin bags to be dispensed, selected from the group of
a) a QR code reader adapted for reading information on a container, or the coin bag or on an information part of a seal;
b) a RFID reader adapted for reading information on the container, or a coin bag or on the information part of a seal; and
c) a means for manually entering information such as a key pad.

8. The dispensing apparatus of claim 1, further comprising a sensor for detecting the position of the chain of a plurality of interconnected coin bags in the transition area.

9. The dispensing apparatus of claim 1, further comprising a means for receiving a sensor signal from a container in said first storage position, said signal indicating presence of a chain of interconnected coin bags in said container.

10. The dispensing apparatus of claim 1, further comprising a control system for controlling at least the cutting device. first conveyor belt, bag transporting device, and the container removing device.

11. The dispensing apparatus of claim 10, wherein said control system is adapted for receiving information about the amount of interconnected coin bags of the chain in the container in the first storage position, said control system being adapted to determining in real time whether there are any interconnected coin bags left in the container, and if the control system has determined that there are no remaining interconnected coin bags in the container, the control system is adapted to instruct the container removing device to transfer the container to the output compartment.

12. The dispensing apparatus of claim 11, wherein the control system determines whether there are any interconnected coin bags left in the container based one or more of the following input data:
i) information from a means for obtaining amount information about the coins and/or coin bags to be dispensed selected from the group of
a) a OR code reader adapted for reading information on a container, or the coin bag or on an information part of a seal;
b) a RFID reader adapted for reading information on the container, or a coin bag or on the information part of a seal; and
c) a means for manually entering information such as a key pad;
ii) information from a sensor for detecting the position of the chain of a plurality of interconnected coin bags in the transition area;
iii) information from a means for receiving a sensor signal from a container in said first storage position, said signal indicating presence of a chain of interconnected coin bags in said container; and
iv) information from the cutting device and/or the bag transporting device about the amount of bags that have been transported away from the bag storage compartment.

13. The dispensing apparatus of claim 10, wherein said control system is adapted for instructing the first conveyor belt to forward a container in the bag storage compartment to the first storage position in case there is no container in the first storage position.
